(19) United States
(12) Patent Application Publication
(10) Pub. No.: US 2015/0079235 A1
(43) Pub. Date: Mar. 19, 2015

(54) Hemp-Based Infant Formula and Methods of Making Same

(71) Applicants: Jennifer WRIGHT, (US); David SPRAGUE, Perth (CA)

(72) Inventors: Jennifer Wright, Perth (CA); David Sprague, Perth (CA)

(21) Appl. No.: 14/385,580

(22) PCT Filed: Mar. 18, 2013
(86) PCT No.: PCT/CA2013/000262

§ 371 Date: Sep. 16, 2014

Related U.S. Application Data
(60) Provisional application No. 61/611,780, filed on Mar. 16, 2012.
(60) Provisional application No. 61/710,326, filed on Oct. 5, 2012.

(51) Int. Cl. A23L 1/29; A23L 1/304; A23L 1/305; A23J 1/14; A23L 2/66; A23L 1/302; A23L 1/30

(52) U.S. Cl. CPC A23L 1/296; A23L 1/302; A23L 1/304; A23L 1/3014; A23J 1/14; A23L 2/66; A23L 1/3055; A23L 1/3056; A23V 2002/00
USPC 426/61; 426/601; 426/588; 426/72

(57) ABSTRACT

The present invention pertains to the field of nutrition and in particular a food product formulation based on protein and other nutrients extracted from oil seeds, such as hemp, for a plurality of uses, including, but not limited to an infant or toddler formula, a beverage, baked goods or a protein supplement. Suitable oil seeds include, but are not limited to hemp, flax, chia, pea and spirulina. Accordingly, the present invention provides a food product formulation for human consumption that can provide a complete source of dietary protein and other nutrients through oil seed protein. The formulation may be prepared in a variety of product forms, including but not limited to, a ready-to-serve liquid form, or a powder form that can be reconstituted prior to human consumption into liquid form, or a powder form that can be added to oilier ingredients to produce a baked product for human consumption, or a protein supplement.

### FIELD OF THE INVENTION

The present invention pertains to the field of nutrition and in particular a food product formulation based on protein and other nutrients extracted from oil seeds such as hemp, for a plurality of uses, including, but not limited to an infant or toddler formula, a beverage, baked goods or a protein or other nutritional supplement.

### BACKGROUND OF THE INVENTION

It has long been recognized that protein and lipids are fundamental building blocks for healthy human development for all age groups and genders. Dietary protein provides many essential functions in the human body, the main one being the supply of essential amino acids (“EAA's”) required for the growth and maintenance of human tissue. It also functions as enzymes and antibodies in the body and has been described as the structural backbone of tissues, hormones and blood (Hemp Basics 16/12/2011). Lipids, or essential fatty acids, are essential for proper development, function and healing of all tissues and organs and the maintenance of all the body's systems

From the perspective of infants and children, dietary protein, EAA's and essential fatty acids (EFAs) in particular, are of critical importance, due in large part to the significant growth and development during this time period. While proteins and lipids are of critical importance in the human diet, there are often many challenges in meeting dietary protein and lipid requirements, particularly for specific age groups and subpopulations, such as infants, toddlers, youth, those who are dietarily challenged, and vegans or vegetarians.

Current infant and toddler formulas and protein supplement products face challenges. They are often associated with adverse effects, such as food intolerance, gastrointestinal upset, etc. For example, there are a wide number of infant and toddler formulas and protein supplements that are milk-based. Human milk derives all of its carbohydrate calories from lactose, as do most milk-based formulas. Many individuals have difficulty digesting these products due to lactose intolerance.

Alternative products based on plant sources, such as soy-milk or soy formula can be problematic. Plant proteins are generally viewed as incomplete protein sources, since they often contain insufficient amounts of one or more of the FAA's. Moreover, dairy and soy protein isolate powders tend to be processed with chemicals, such as hexane. Soy proteins also contain oligosaccharides, which have been associated with stomach upset and gas in some individuals. In infants in particular, soy based formulas can create feeding intolerance challenges that can lead to fussiness, constipation, or other gastrointestinal difficulties. Lastly, infant and toddler formula products rely on the addition of highly processed, refined carbohydrate sources and sugars and the use of genetically modified ingredients.

Given the foregoing, there is a need for a product that can be used across all age and gender groups, particularly among infants, children and youth, to supply a complete vegetarian dietary source of proteins, lipids carbohydrates, vitamins and minerals that will serve as a soul nutritional source. There is also a need for a product that is not associated with adverse effects, such as feeding intolerance and gastrointestinal issues.

While protein extracted from hemp seed is extremely beneficial from a nutritional standpoint, hemp based food products on the market have not been directed to utilizing hemp in a manner that will provide a complete source of dietary nutrition for specific age groups and subpopulations, nor in a manner that will maximize nutritional absorption.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide in at least one embodiment an oil seed-based food product formulation and method of making same,

In certain embodiments, the oil seed-based food product formulation will be an infant formula composition, comprising hemp as a nutritional source.

Accordingly, as an aspect of the invention, there is provided an infant formula composition comprising protein, carbohydrates and lipids effective to supply, per 100 calories, between about 1.8 and 4.5 g of protein, between about 3.3 and 6 g of lipids, and between about 9 and 14 g of carbohydrates, the formulation also comprising between about 1 and 100 of a daily recommended intake of vitamins and minerals, wherein said formulation comprises hemp or a hemp derivative as at least one source of protein, carbohydrate, lipids, vitamins or minerals, or a combination thereof.

In certain embodiments, the hemp or hemp derivative may comprise from 0.1 to 100 weight percent of the composition, including 1, 2, 3, 4, 5, 6, 7, 8, 9, 10, 15, 20, 25, 50, 75, 85, 95 weight percent of the composition. Other components of the composition, for example dairy and/or other nutritional sources, may make up the remainder of the composition. Thus, it is envisioned that various ratios of hemp or hemp derivative sources may be present in a ratio with, e.g. dairy and/or other bases or additives, for example, from 0.1:99.9 up to 99.9:0.1 in the composition, to make up the nutritional requirements of the composition. This will typically depend on the selection of the nutritional sources and the application of the particular formula desired.

In certain embodiments, the hemp or hemp derivative may comprise hulled or dehulled hemp seed, hemp concentrate, hemp protein powder, hemp isolate, hemp oil, hemp liquid or a combination thereof.

In certain embodiments, the composition comprises a protein source in addition to said hemp or a hemp derivative including: hemp protein, hemp protein isolate, hemp milk, whey powder, whey protein isolate, whey protein concentrate, milk protein isolate, milk protein concentrate, non-fat milk, non-fat milk isolate, non-fat milk concentrate, casein, skim milk, skim milk powder, skim milk isolate, skim milk concentrate, reduced mineral whey, partially hydrolyzed non-fat milk, fully hydrolyzed non-fat milk, partially hydrolyzed whey protein, fully hydrolyzed whey protein, soy protein, soy protein isolate, casein hydrolysate, free amino acids, amino acids, 100 free amino acids, small peptides, L-amino acids, rice concentrate, pea isolate, pea concentrate, goat's milk protein, goat's milk protein isolate, goat's milk protein concentrate, spirulina, aphanizomen-flos aquae (AFA), clergy sage, chia, flaxseed, yellow pea, quina, camu-camu, chlorella, dolse, and kelp.

In certain embodiments, the composition comprises a lipid source in addition to said hemp or a hemp derivative including: hemp milk, hemp oil, rice concentrate, pea isolate, pea concentrate, goat's milk fat, cow's milk fat, high oleic vegetable oil, soy oil, medium-chain triglyceride (MCT) oil, long-chain triglyceride (LCT) oil, coconut oil, docosahexaenoic acid (DHA), arachidonic acid (ARA), palm olein oil, high oleic sunflower oil, refined vegetable oil, monodiglycerides, corn oil, safflower oil, palm kernel oil, algal oil, aphanizomen-flos aquae (AFA), spirulina, clergy sage oil, evening primrose oil, flaxseed oil, rice bran oil, soy lecithin, oatbran oil, phenylethylamine (PEA), and lipogen; preferably hemp oil and a source of ALA (alpha linoleic acid).

In certain embodiments, the composition comprises a carbohydrate source in addition to said hemp or a hemp derivative including: lactose, corn syrup, maltodexrin, corn syrup solid, high fructose corn syrup, corn, corn maltodextrin, sucrose, modified tapioca starch, modified corn starch, tapioca starch, rice starch, fructose, yucon, dextrin, wood sugar, coconut palm sugar, coconut crystals, coconut sugar, agave, palm nectar and coconut sap sugar; preferably coconut sap sugar, coconut palm sugar, crystallized coconut sap, palm nectar, wood sugar, raw honey, honey, crystallized honey, agave, yacon, or sweet potato, more preferably coconut palm sugar.

In certain embodiments, the protein, lipid and carbohydrates are all partially derived from the hemp or hemp derivative.

In certain embodiments, the vitamins and minerals comprise calcium, phosphorus, sodium, chloride, magnesium, manganese, iron, copper, zinc, selenium, iodine, Vitamins A, C, D, K and the B complex, and combinations thereof.

In certain embodiments, the vitamins and minerals are added separately, are whole food derived, or a combination thereof.

In certain embodiments, the hemp or hemp derivative comprises hulled or dehulled hemp seed.

In certain embodiments, the composition further comprises as at least one source of protein, carbohydrate and lipids, in addition to the hemp or hemp derivative, a dairy, rice, hydrolyzed, goat milk, or soy based composition or formula.

In certain embodiments, the infant formula composition is formulated as a powder, liquid, concentrate, flakes, tablet or capsule.

In certain embodiments, the infant formula composition is dehydrated using a process selected from the group consisting of spray drying, freeze drying, microwave drying or refractory window dehydration.

In certain embodiments, an emulsifier is added in an amount effective to stabilize the lipids and increase shelf life of the infant formula composition.

In certain embodiments, the composition further comprises at least one prebiotic and/or at least one probiotic.

In certain embodiments, the composition further comprises a biotic such as Bifidobacterium spp., Clostridium spp., Bacteroides spp. Enterococcus faecalis, E. coli, Enterobacter cloacae, Klebsiella pneumoniae, Staphylococcus epidermidis, Staphylococcus haemolyticus, or Lactoferrin.

In certain embodiments, the composition further comprises a source of DHA such as plant algae (AFA or Blue Green Algae), algal oil, and fish oil sources of DHA.

In certain embodiments, the composition further comprises at least one stabilizer including gum arabic, gum ghatti, gum karaya, gum tragacanth, agar, furcellaran, guar gum, gellan gum, locust bean gum, pectin, low methoxyl pectin, gelatin, microcrystalline cellulose, CMC, methylcellulose hydroxypropyl methyl cellulose, hydroxypropyl cellulose, dextran, carrageenans, and combinations thereof.

In certain embodiments, the composition is a dry powder ready to blend with water, juice, dairy milk or a plant based beverage; a pasteurized or unpasteurized ready to serve liquid; a pasteurized or unpasteurized frozen liquid to be thawed and warmed before consumption; or a pasteurized or unpasteurized concentrated liquid or frozen concentrate ready to add to water, juice, dairy milk or plant based beverage.

In certain non-limiting embodiments, the composition comprises
hemp seed at about 1 weight percent of the composition,
rice concentrate, whey powder, whey protein isolate, skim milk powder, milk protein concentrate, pea isolate or a combination thereof at about 61 weight percent of the composition,
lactose at about 19 weight percent of the composition, and safflower oil, high oleic at about 19 weight percent of the composition.

In certain further non-limiting embodiments, the composition comprises
hemp seed at about 2.5 weight percent of the composition,
rice concentrate, whey powder, whey protein isolate, whey protein concentrate, skim milk powder, milk protein concentrate, pea isolate or a combination thereof at about 59 weight percent of the composition,
lactose at about 19.5 weight percent of the composition, and safflower oil, high oleic at about 19 weight percent of the composition.

In certain further non-limiting embodiments, the composition comprises
hemp seed at about 4.9 weight percent of the composition,
rice concentrate, whey powder, whey protein isolate, whey protein concentrate, skim milk powder, milk protein concentrate, pea isolate or a combination thereof at about 56.1 weight percent of the composition,
lactose at about 19.5 weight percent of the composition, and
safflower oil, high oleic at about 19.5 weight percent of the composition.

In certain further non-limiting embodiments, the composition comprises
hemp seed at about 36.4 weight percent of the composition,
rice concentrate, whey powder, whey protein isolate, whey protein concentrate, skim milk powder, milk protein concentrate, pea isolate or a combination thereof at about 27.2 weight percent of the composition,
lactose at about 27.3 weight percent of the formulation, and
safflower oil, high oleic at about 9.1 weight percent of the composition.

In certain further non-limiting embodiments, the composition comprises
hemp seed at about 32.6 weight percent of the composition,
rice concentrate, whey powder, whey protein isolate, whey protein concentrate, skim milk powder, milk protein concentrate, pea isolate or a combination thereof at about 14 weight percent of the composition,
lactose at about 41.8 weight percent of the composition, and
safflower oil, high oleic at about 11.6 weight percent of the composition.

In certain further non-limiting embodiments, the composition comprises
hemp powder at about 30 weight percent of the composition
rice concentrate, whey powder, whey protein isolate, whey protein concentrate, skim milk powder, milk protein concentrate, pea isolate or a combination thereof at about 15 weight percent of the composition,
lactose at about 35 weight percent of the composition, and
safflower oil, high oleic at about 20 weight percent of the composition.

In certain further non-limiting embodiments, the composition comprises
hemp powder at about 29 weight percent of the composition
rice concentrate, whey powder, whey protein isolate, whey protein concentrate, skim milk powder, milk protein concentrate, pea isolate or a combination thereof at about 9 weight percent of the composition,
lactose at about 38 weight percent of the composition, and
safflower oil, high oleic at about 24 weight percent of the composition.

In certain further non-limiting embodiments, the composition comprises
hemp isolate at about 30 weight percent of the composition
rice concentrate, whey powder, whey protein isolate, whey protein concentrate, skim milk powder, milk protein concentrate, pea isolate or a combination thereof at about 15 weight percent of the composition,
lactose at about 38 weight percent of the composition, and
safflower oil, high oleic at about 17 weight percent of the composition.

In certain further non-limiting embodiments, the composition comprises
hemp isolate at about 32 weight percent of the composition,
rice concentrate, whey powder, whey protein isolate, whey protein concentrate, skim milk powder, milk protein concentrate, pea isolate or a combination thereof at about 9 weight percent of the composition,
lactose at about 41 weight percent of the composition, and
safflower oil, high oleic at about 18 weight percent of the composition.

In certain further non-limiting embodiments, the composition comprises
hemp liquid at about 5 weight percent of the composition
rice concentrate, whey powder, whey protein isolate, whey protein concentrate, skim milk powder, milk protein concentrate, pea isolate or a combination thereof at about 56 weight percent of the composition,
lactose at about 19.5 weight percent of the composition, and
safflower oil, high oleic at about 19.5 weight percent of the composition.

In certain additional non-limiting embodiments, the the hemp or hemp derivative comprises hemp liquid, and the hemp liquid is added in an effective amount for fortification of said protein, carbohydrates, lipids or combination thereof.

In further aspects of the invention, there is also provided the use of a composition described herein as a nutritional source or supplement for infants or children with allergies or an intolerance to foods, for improving protein absorption, for improving digestion in infants, and/or to supplement human breast milk.

In other aspects of the invention, there is also provided the use of a composition described herein as a nutritional source or supplement for subjects having or at risk of, or for prevention of heart disease, diabetes, obesity, digestive ailments, autism, ADHD, or ADD, or for increasing lactation or increasing nutritional content of breast milk in lactating women.

In additional aspects of the invention, there is also provided the use of a composition described herein as a nutritional source or supplement for supplementing essential fatty acids (EFAs). In certain non-limiting embodiments, the supplementing of EFAs may support healthy brain development.

There are also provided methods of treatment, which involve administering to a human subject a composition described herein as a nutritional source or supplement, including for the medical uses described above. Compositions for use in such methods are also provided.

As a further aspect of the invention, there is also provided a method for producing an infant formula composition, the method comprising:
dispersing a quantity of at least one hemp or hemp derivative source in water or milk to solubilize the hemp or hemp derivative source and form a solution;
optionally removing solid material from said solution; and
adding protein, carbohydrate and/or lipid sources in amounts to balance the composition, per 100 calories, with between 1.8 and 4.5 g of protein, between 3.3 and 6 g of lipids, with optional quantities of carbohydrates, and between 1 and 100 of a daily recommended intake of vitamins and minerals.

In certain further non-limiting embodiments of the method, in addition to said quantity of at least one hemp or hemp derivative source, between 0 and 4.5 g of a protein source, between 0 and 6 g of a lipids source, between 0 and 14 g of a carbohydrates source are added to the composition to supplement the nutritional content of the hemp seed or hemp derivative.

In certain further non-limiting embodiments of the method, the protein, lipids and carbohydrate content are further adjusted to meet special nutritional requirements of premature infants, infants of low birth weight, or infants with special nutritional requirements due to illness or other health issues.

In certain further non-limiting embodiments of the method, the hemp or hemp derivative source comprises hulled or dehulled hemp seed, hemp concentrate, hemp protein powder, hemp isolate, hemp oil, or a combination thereof.

In certain further non-limiting embodiments of the method, all sources are mixed with water or milk to form said solution.

In certain further non-limiting embodiments of the method, the method further comprises:
dissolving at least one protein source in water to form a protein solution, dissolving at least one lipid source in water to form a lipid solution, and optionally dissolving at least one carbohydrate source in water to form a carbohydrate solution;
mixing at least one source of minerals and/or vitamins in water to form a mineral/vitamin solution;
combining quantities of said protein, lipid and optional carbohydrate solutions, and said mineral/vitamin solution to balance the infant formula, per 100 calories, with between 1.8 and 4.5 g of protein, between 3.3 and 6 g of lipids, between 0 and 14 g of carbohydrates, and between 1 and 100 of a daily recommended intake of vitamins and minerals, and
optionally adding water, milk or both to dilute the combined solution to a desired caloric density.

In certain further non-limiting embodiments, the method further comprises heat processing and homogenizing the solutions once combined.

In certain further non-limiting embodiments of the method, the at least one hemp or hemp derivative source and the protein, carbohydrate, vitamins, minerals and/or lipid sources are all blended in dry form to obtain a homogeneous product

In certain further non-limiting embodiments of the method, the heat processing and/or homogenizing takes place before or after a portion of the ingredients have been combined.

In certain further non-limiting embodiments, the method further comprises preheating and drying the solutions once combined, under conditions which do not denature the proteins, to obtain a powder.

In certain further non-limiting embodiments of the method, the at least one hemp or hemp derivative source comprises hemp seed and the hemp seed is dispersed in the water, milled to form a slurry, and the slurry is further screened to remove fiber content.

In certain further non-limiting embodiments of the method, the hemp seeds are presoaked in water, then milled to form said slurry.

In certain further non-limiting embodiments, the method further comprises adding one or more sweeteners, flavouring, stabilization aids, and/or coloring.

In certain further non-limiting embodiments, the method further comprises homogenizing, sterilizing, aseptically packaging, pasteurizing or deodorizing the at least one hemp or hemp derivative source and/or said composition, or a combination of two or more thereof.

In certain further non-limiting embodiments of the method, hemp seed is combined with water to form a slurry, a solid fraction of the hemp seed is removed from a liquid fraction of the slurry, the liquid hemp slurry is further combined with a source of dairy in slurry form, a source of dairy, or other formula base in slurry form, said vitamins and minerals are added to form a liquid slurry mixture, and the liquid slurry mixture is spray dried under high velocity through a fine nozzle of a size effective to produce dried particles effective to reduce fat separation and increase shelf life.

In certain further non-limiting embodiments of the method, hemp protein powder or hemp isolate is combined with a source of dairy or other base in slurry form, said vitamins and minerals are added to form a liquid slurry mixture, and the liquid slurry mixture is spray dried.

In certain further non-limiting embodiments of the method, liquid and solid fractions are separated by centrifuge.

In certain further non-limiting embodiments of the method, hemp seed is processed by rough grinding, followed by fine grinding to breakdown the seed into smaller particles.

In certain further non-limiting embodiments of the method, the rough and fine grinding steps are carried out in water. Additionally, it may be desirable in further embodiments for the water to be heated.

In additional, yet non-limiting embodiments of the method, the hemp seeds may be heated to remove the shell prior to blending or grinding the seed.

There is also provided a method of preparing an oil seed-based food product formulation for human consumption comprising:
blending oil seeds and water in a high speed blender to form a slurry; and
pressing the slurry through a separation device to provide a liquid fraction and a solid fraction.

In certain further non-limiting embodiments of the above method, the oil seeds and water are blended to form a slurry in the absence of heat.

In certain further non-limiting embodiments of the method, the oil seeds are hulled.

In certain further non-limiting embodiments of the method, the separation device is a fine mesh strainer, a nut press, a traditional seed mill, a centrifuge, a cold seed mill or an industrial press.

In certain further non-limiting embodiments of the method, the slurry is pressed through the separation device at least twice.

In certain further non-limiting embodiments of the method, the liquid is freeze-dried and crushed to a powder.

In certain further non-limiting embodiments of the method, the formulation is packaged in pre-sterilized containers.

In certain further non-limiting embodiments of the method, the containers are heat and/or light resistant.

In certain further non-limiting embodiments of the method, the liquid fraction is pasteurized prior to packaging.

In certain further non-limiting embodiments of the method, the liquid is packaged in containers and flash frozen.

There is also provided, according to the invention, a method of preparing an oil seed-based food product formulation for human consumption comprising:
blending hulled oil seeds to separate an liquid from a solid fraction;
sifting the liquid fraction to remove remaining solids; and
dehydrating the liquid fraction.

In certain further non-limiting embodiments of the above method, the dehydrated liquids are blended with a plurality of other dehydrated ingredients.

In certain further non-limiting embodiments of the method, the formulation is packaged in pre-sterilized containers.

In certain further non-limiting embodiments of the method, the containers are heat and/or light resistant.

In certain further non-limiting embodiments of the method, the oil seeds and water are blended to form a slurry in the absence of heat.

In certain further non-limiting embodiments of the method, the oil seeds are blended with a plurality of ingredients.

In certain further non-limiting embodiments of the method, the formulation is packaged in pre-sterilized containers.

In certain further non-limiting embodiments of the method, the containers are heat and/or light resistant.

In certain further non-limiting embodiments, the method further comprises mixing said formulation with flavouring.

In certain further non-limiting embodiments of the method, the oil seeds are selected from the group consisting of hemp, flax, chia, pea and spirulina.

In certain further non-limiting embodiments, the method further comprises the step of:
pasteurizing the liquid fraction.

In certain further non-limiting embodiments, the method further comprises the step of;
adding the oil seed-based food product formulation to an existing food product.

In certain further non-limiting embodiments, there is also provided an oil seed-based food product formulation for human consumption produced by the above methods.

The is also provided, in other non-limiting embodiments, the use of the oil seed-based food product formulation in providing an infant nutritional regime, wherein the oil seed-based food product formulation forms part of or the entirety of the infant nutritional regime.

In further non-limiting embodiments of the above methods, the resulting powder may in certain non-limiting embodiments be passed through bag filters to avoid powder loss.

In further embodiments of the above methods, a fluidized spray drier may be employed to produce an agglomerated free flowing powder.

In further non-limiting embodiments of the above methods, the water used for extracting the hemp may contain nutrients and/or carbohydrates, and be concentrated, further mixed with undissolved proteins from the extraction process, processed and dried to be used as animal feed.

In further non-limiting embodiments of the above methods, the homogenization may be carried out under high pressure to turn the lipids into microscopic particle size.

### BRIEF DESCRIPTION OF THE DRAWING

These and other features of the invention will become more apparent in the following detailed description in which reference is made to the appended drawings.

FIG. 1 presents a flow diagram of an example of an embodiment of a method for the production of hemp milk,

FIG. 2 presents a flow diagram of an example of an embodiment of a method for the production of hemp protein isolate.

FIG. 3 presents a flow diagram of an example of an embodiment of a method for the production a nutritional powder form.

FIG. 4 presents a schematic diagram of an example of a spray drying system for the production a nutritional powder form.

### DETAILED DESCRIPTION OF THE INVENTION

### Definitions

Unless defined otherwise, all technical and scientific terms used herein have the same meaning as commonly understood by one of ordinary skill in the art to which this invention belongs.

The term “infant” as used herein includes children up to one year corrected age, and includes infants from 0 to about 4 months corrected age, low birth weight infants less than 2,500 grams at birth, and premature infants born at less than about 37 weeks gestational age, typically from about 26 weeks to about 34 weeks.

The term “infant formula” refers to nutrition compositions designed for infants, which preferably contain sufficient protein, carbohydrate, lipid, vitamins, minerals, and electrolytes to potentially serve as the sole source of nutrition when provided in sufficient quantities. These formulas, therefore, can be used to provide sole, primary, or supplemental nutrition for the intended infant or infant population.

The term “toddler” as used herein includes children between twelve and thirty six months of corrected age.

All percentages, parts, and ratios used herein are by weight of the total composition, unless otherwise specified. All such weights as they pertain to listed ingredients are based on the active level and therefore do not include solvents or by-products that may be included in commercially available materials, unless otherwise specified.

All combinations of method or process steps as used herein can be performed in any order, unless otherwise specified or clearly implied to the contrary by the context in which the referenced combination is made.

As used herein, the term “about” refers to a +/−10% variation from the nominal value. It is to be understood that such a variation is always included in a given value provided herein, whether or not it is specifically referred to.

The present invention relates to the use of hemp and hemp derivatives as an infant formula base, which can be used as an alternative to soy, rice, dairy or other infant formula bases.

In addition, the present invention relates to a novel infant formula base derived from hemp or a hemp derivative, such as hemp oil seeds. The invention is also directed to the use of the infant formula base in combination with other infant formula bases, and for a plurality of uses. Also described are examples of compositions comprising protein, lipid, carbohydrate, vitamins and minerals, wherein full or part of the content of these ingredients are derived from hemp or a hemp derivative. Also disclosed are methods of manufacture, and methods for the treatment of a variety of infant health conditions through the use of these compositions. The invention is also directed, as a result, to nutritional products.

In addition, the present invention relates to the use of hemp seed, hemp compositions and hemp derivatives as a nutritional additive to current formula bases. Thus, hemp based infant formulas can also be combined with milk base, soy base, rice base, hydrolyzed base and other marketed formula bases to improve upon their nutritional value.

Other oil seeds in addition to hemp seed, such as flax seed and chin seed, legumes such as pea, and nutritional supplements such as spirulina may also be utilized in providing a food product that will provide a complete source of dietary protein, in an analogous manner as described above.

The benefits of using oilseeds such as hemp in infant formula are many. They are lactose-free, and offer a vegetarian alternative to milk based infant formulas. Hemp based infant formulas are also of significant benefit for infants with intolerance to cow milk. Hemp can be added in varying amounts and in any combination to achieve a particular fortification level with other marketed bases.

Hemp can also be added in different forms to achieve a particular or desired fortification level. For example, yet without wishing to be limiting, the hemp can be provided in the form of a hulled and dehulled hemp seed, hemp concentrate, hemp protein powder, hemp isolate, hemp oil, hemp milk, or powdered hemp milk.

The present invention also pertains to hemp based compositions and combinations with other formulations, including but not limited to dairy, soy, rice or hydrolyzed formulations. Hemp therefore can be used in fortified milks designed for children, combined with regular, speciality, and paediatric formulas, and generally as a hemp base for nutritional supplementation of various other formulations.

In currently marketed formulas, each ingredient generally serves only one function. Thus, the protein, lipids, carbohydrates, vitamins and minerals are all obtained by adding individual ingredients. The present invention aims to offer a source material that is rich in proteins, lipids, carbohydrates, vitamins, and minerals, such that all or a significant amount of these nutrients can be provided from fewer ingredients, and without need for significant levels of processing such that a more natural nutritional source can be provided.

The hemp-based formulas described herein may also be provided in toddler formulations, follow on formulas, nutritional supplements, dietary supplements, milk beverages, and other compositions in which protein or other nutritional supplementation is desired.

In addition, the hemp-based formulas described herein may also be provided as a supplement to assist with lactation, for nutrition in elderly persons, as a pregnancy supplement, for DNA repair, as a reproduction aid or supplement for male/female infertility, as a dietary supplement for children, youth or adults, for treatment of undernourishment individuals, as a supplement to assist with treating degenerative diseases, depressive disorders or other health issues, or as a weight loss/weight control aid. The hemp-based formulas described herein may also be added to foods and snacks for adults and children to increase nutritional content, including nutritionally potent snacks to enhance/develop metal clarity, focus and energy. For example, yet without wishing to be limiting in any way, the hemp-based formulas described herein may be added to infant foods, nutritional supplements for children, snacks, bars, beverages, yogurt, cereal, porridge, frozen treats, ice cream, etc.

In one non-limiting embodiment of a method for preparing a hemp-based or hemp-blended formula, an aqueous slurry is formed by mixing full hulled hemp seed with water. The slurry is further processed to remove the solid fraction from the liquid fraction, and the liquid hemp is then used by itself or added to e.g. liquid dairy, soy or other formula base to form either a hemp composition or a blended composition. The composition is then further fortified as needed to balance the nutritional profile, additional proteins, lipids and carbohydrates may be added, vitamins and minerals may be added, and other optional ingredients may be added to produce the hemp-based or hemp-blended formula. The composition may optionally be blended into a homogenized liquid mixture, and then dried to form a powder or simply left in liquid form as a ready to serve product.

In other methods of preparing the formulation described herein, all ingredients can be combined in dry powder form, and further processed by mixing, milling, and/or blending techniques as known in the art.

When provided in a liquid form, the formulation may be supplied as a ready-to-feed liquid, or as a concentrated liquid requiring dilution with additional water before feeding.

When provided in a solid form, the formulation may be in a powdered form requiring addition with water prior to use, in a flake form requiring addition of water prior to use, or in other forms as would be apparent to the skilled person.

In non-limiting embodiments, the full hulled hemp seed may advantageously be used such that all of the fat from the seed remains in the milk, which adds a pleasant texture and full fat flavour to the milk. It also adds the full benefits of the nutrients from the seed, including added proteins, fats, carbohydrates, vitamins and minerals.

In a further non-limiting embodiment, the hemp can be added to the dairy, rice, soy, or other base ingredient by the direct addition of a hemp concentrate, hemp protein powder, hemp isolate, hemp oil or hemp derivative into the liquid base ingredient. The hemp concentrate, hemp protein powder, hemp isolate, hemp oil or hemp derivative may be in dry and/or liquid form, or a combination thereof as needed to achieve desired results.

In yet another non-limiting embodiment, a source ingredient such as dairy, soy or rice may be added to a liquid hemp source, e.g. with the direct addition of whey, casein, whey concentrate, and/or other ingredients.

In the embodiments of the invention described herein, numerous different ingredients as known to one skilled in the art, as expressed in prior art, may be combined with the hemp source as needed to bring the nutritional content to desired levels.

In certain embodiments, which are non-limiting, protein sources may include: hemp seed, hemp protein, hemp protein isolate, hemp milk, whey powder, whey protein isolate/concentrate, milk protein isolate/concentrate, non-fat milk, non-fat milk isolate/concentrate, casein, skim milk, skim milk powder, skim milk isolate/concentrate, reduced mineral whey, partially hydrolyzed non-fat milk, fully hydrolyzed non-fat milk, partially hydrolyzed whey protein, fully hydrolyzed whey protein, soy protein, soy protein isolate, casein hydrolysate, free amino acids, amino acids, 100% free amino acids, small peptides, L-amino acids, rice concentrate, pea isolate/concentrate, goat's milk protein, goat's milk protein isolate/concentrate, spirulina, AFA, clergy sage, chia, flaxseed, yellow pea, quinoa, camu-camu, chlorella, dolse, kelp, and all other sources known to one skilled in the art.

In further non-limiting embodiments, lipid sources may include: hemp seed, hemp protein, hemp protein isolate/concentrate, hemp milk, hemp oil, rice concentrate, pea isolate/concentrate, goat's milk fat, cow's milk fat, high oleic vegetable oil, soy oil, MCT oil, LCT oil, coconut oil, DHA, ARA, palm olein oil, high oleic sunflower oil, refined vegetable oil, monodiglycerides, corn oil, safflower oil, palm kernel oil, algal oil, aphanizomen-flos aquae (AFA), spirulina, clergy sage oil, evening primrose oil, flaxseed oil, rice bran oil, soy lecithin, oatbran oil, phenylethylamine (PEA), lipogen, and all other sources known to one skilled in the art.

Carbohydrate sources, in other non-limiting embodiments, may include: lactose, corn syrup, maltodexrin, corn syrup solid, corn syrup solid, high fructose corn syrup, corn, corn maltodextrin, sucrose, modified tapioca starch, modified corn starch, tapioca starch, rice starch, fructose, yucon, dextrin, wood sugar, coconut palm sugar, coconut crystals, coconut sugar, agave, palm nectar, coconut sap sugar, and all other sources known to one skilled in the art.

The formulations of the present invention may also contain one or more additional ingredients useful in such nutritional formulations, including those which are known in the art to be useful, as well as other ingredients that are not commonly used in the art, including spirulina, yellow pea, coconut palm sugar, palm sugar, coconut sap crystals, agave, succant, xylitol, yacon, and whole food vitamins.

Thus, in further additional aspects, the invention relates to nutritional formulations, including but not limited to infant formulas, toddler formulas and nutritional supplements, comprising one or more of coconut palm sugar, palm sugar, coconut sap crystals, agave, succant, xylitol, or yacon, as a carbohydrate or whole food vitamin source.

Also further provided, as additional aspects of the invention, are nutritional formulations including but not limited to infant formulas, toddler formulas and nutritional supplements, which comprise spirulina and/or yellow pea as a source of protein, lipid or carbohydrate, as a whole food vitamin source, or a combination thereof.

In further embodiments, which are not limiting in any way, the source ingredients for the formulation may be obtained from organic sources. In such embodiments, the formulation is substantially free of chemicals, pesticides, antibiotics, hormones, herbicides, non-genetically modified plants and/or chemical solvents.

In certain non-limiting embodiments of the invention, it may be desirable to supply a formula that is low in sugar, reduced in sugar, void of sugar, or made with no refined sugars. Refined sugar is often added in commercial infant formula to bring the formula to the required calorie amount, typically by adding large amounts of refined sugars that may lead to major health concerns such as heart disease, diabetes, obesity, and many others. Thus, for greater health benefits, a formulation as described herein may be prepared that has a low sugar count and/or is made with only unrefined sugars and/or natural sugars. Because hemp is balanced in nutritional content, formulations according to the present invention only require minimal additional sugars to be added. In such embodiments, it may be preferable to use coconut palm sugar or the like as a carbohydrate source additive.

In yet further embodiments, the formulation described herein can be prepared as a powdered hemp milk comprising full fat content. Currently, powdered hemp protein is manufactured by removing the lipid fraction, pressing the protein fraction and then dry blending the resulting powder. According to the formulation and methods of the present invention, the full fat content of the hemp seed can be maintained by adding an emulsifying agent to prevent rancidity, and/or spray drying the liquid at a finer molecule size to prevent the fat from separating.

In a further embodiment, the present invention provides a method for preparing an oil seed-based formulation without the application of heat in any of the processing steps, thereby maximizing the nutritive value of the final product and minimizing the destruction of enzymes and nutrients. Accordingly, the present invention provides a food product formulation for human consumption that can provide a complete source of dietary protein through oil seed protein.

In at least one embodiment, it is contemplated that the ideal oil seed used is hemp seed, however other oil seeds, including but not limited to, chia seed, flax seed, legumes such as pea, and nutrition supplements such as spirulina and AFA are also contemplated for use in connection with the present disclosure. It is contemplated that any of the oil seed-based food product formulations disclosed herein could be produced from just one of the oil seeds discussed herein, or alternatively a combination of two, three or four oil seeds as required by an instant application of the present disclosure. It will be understood that nutritional supplements such as spirulina and AFA are considered analogous to oil seeds for the purposes of the present disclosure.

Hemp protein is unique to other plant proteins because it provides a quality source of

1. Arginine and histidine, which are of paramount importance for growth and development during childhood;
2. Methionine and cysteine, which are needed for the production of enzymes; and
3. Branched chain amino acids, which are essential for the repair and growth of lean body mass.

Approximately ⅔ of hemp protein is made up of the globulin protein edestin, which is similar to the protein found in human blood plasma, thereby making it particularly suitable for meeting the body's cellular needs and also easily digested and assimilated in the human body.

Hemp protein has several advantages to other plant proteins. In addition to being a complete source of dietary protein and EAA's in particular, hemp protein can be extracted from hemp seed using cold pressing techniques, thus avoiding the addition of harmful chemicals or heat during the processing, or the destruction of enzymes, vitamins and minerals in the final food product.

Food products based on hemp are generally free of known allergens and oligosaccharides, the latter of which is found in many soy protein products and have been associated with gastrointestinal problems (Hemp Basics 16/12/2011).

In at least one embodiment the oil seed-based food product of the present invention is produced through a formulation that comprises sufficient types and amounts of nutrients to help meet the targeted needs to the user. The user can range from a plurality of age groups as well as specific populations, including but not limited to, infants, toddlers, children, pregnant and lactating women, men of reproductive age and vegans or vegetarians. In one embodiment of the invention, the formulation comprises protein from oil seeds, lipids, carbohydrate, and preferably further comprises one or more of vitamins, minerals or combinations thereof. As discussed above, suitable oil seeds include, but are not limited to, hemp seed, chin seed, flax seed, and additional plant protein sources such as pea and spirulina. Such suitable oil seeds can be used either in combination or singularly to achieve the desired nutritional profile required by the instant application for the present disclosure.

Many different sources and types of proteins, carbohydrates, lipids, minerals and vitamins are known and can be used in the formulation of the present invention provided that such nutrients are compatible with the added ingredients in the selected formulation, are safe and effective for their intended use and do not otherwise unduly impair the product performance.

It is also contemplated that a number of nutritional additives, including but not limited to, whey protein, soy meal, glucosamine, digestive enzymes, dehydrated milk powder, vitamins, sodium, cellulosic fibre, among any other suitable nutritional additives may be added to the hemp oil-seed based food composition of the present invention as will be readily understood by the skilled person. These nutritional additives will be selected to provide a nutritional profile that is well-suited to the intended application of the present invention.

The formulation may be prepared in a variety of product forms, including but not limited to, a ready-to-serve liquid form, or a powder form that can be reconstituted prior to human consumption into liquid form, or a powder form that can be added to other ingredients to produce a baked product for human consumption, or a protein supplement.

The formulation may be prepared by mixing hemp oil seeds, water and optionally a plurality of other ingredients. The solid fraction is dehydrated and processed to form a powder. The liquid fraction can be utilized as is or the liquid can be freeze-dried and further processed to form a fine powder.

With respect to the method for preparing an oil seed-based liquid formulation, in one embodiment, oil seeds are mixed with water in a high speed blender in the absence of heat to produce a slurry. The liquid is separated from the slurry through a separation device. This separation step is important to separate out the liquid, as well as remove any remaining hull from the oil seed that can adversely impact the absorption of nutrients in the final product. The resulting liquid can be utilized for various food products, including but not limited to, infant formulas, toddler formulas or beverages.

In embodiments where the present invention is employed as an infant formula, it is contemplated that the infant formula can form the entirety of an infant nutritional regime. In such embodiments, the oil seed-based food product formulation of the present invention may be combined with other nutritional supplements in order to provide an infant nutritional regime that comprehensively supplies all of the essential vitamins, minerals, lipids, carbohydrates, proteins and other nutritional characteristics that are required in the early stages of human life, in an analogous manner as mother's milk or other infant formulas.

In another embodiment, the oil seeds are mixed with a plurality of ingredients prior to blending. In another embodiment, the oil seeds are hulled prior to mixing. In another embodiment the separation device is a fine mesh strainer, a traditional seed mill, a cold seed mill, a nut press, an industrial sieve, or centrifuge. In another embodiment, the liquid formulations described above are mixed with one or more flavours, including but not limited to, vanilla bean, choca-maca and assorted fruit flavours. In another embodiment, the liquid is pasteurized prior to packaging. In another embodiment, the liquid is flash frozen before or after packaging.

In another embodiment, the liquid formulation described above is freeze-dried and crushed to a powder. The freeze-drying is a method of dehydration in which the material is frozen and then the surrounding pressure is reduced to allow the water in the material to sublimate from the solid phase directly into the gas phase. This method is advantageous, and unique from other infant and toddler formulas currently on the market, as it allows for optimal enzyme retention during processing while maintaining shelf life. The resulting powder can be utilized for various products, including but not limited to, infant and toddler formula, prenatal supplements, adult protein supplement as well as in other food products.

With respect to the method for producing the oil seed-based powder formulation, in one embodiment, oil seeds are mixed with water in a high speed blender. In some embodiments, this blending will take place in the absence of heat. The liquid is removed from the slurry through a separation device, leaving a solid fraction. The solid fraction is then dehydrated and processed to form a powder.

In another embodiment, the separation device is a fine mesh strainer, a nut press, an industrial sieve or centrifuge. In another embodiment, the powder is added to a plurality of other ingredients to make various food products, including but not limited to, baked goods such as cookies and nutrition bars.

The formulation may optionally include a pre-soaking step for oil seeds wherein the oil seeds are soaked in water for approximately eight hours.

In at least one embodiment, the step of dehydrating the liquid fraction is performed such that during this process the fraction is never heated over 115° C. in order to maintain the integrity of enzymes.

The above-mentioned step of dehydrating can be achieved in any number of ways that will be readily apparent to the skilled person depending on the availability of particular equipment and the needs of the instant application of the present disclosure, among other possible considerations. For example, the liquid fraction may be dehydrated using freeze-drying techniques, spray-drying techniques, refractory window drying techniques, drum drying techniques, solar greenhouse and tunnel drying techniques, absorption drying techniques, hot box drying techniques, indirect convection drying techniques, combined indirect and direct drying techniques, compressed air drying techniques, regenerative drying techniques, refrigerated drying techniques, deliquescent drying techniques, membrane drying techniques, infrared zone drying techniques and microwave vacuum drying techniques, among any other suitable dehydration techniques that will be readily understood by the skilled person.

As will be understood by the skilled person, it is contemplated that in some embodiments a pasteurization step will be undertaken at some point in the process of making the oil seed-based food product formulation. Appropriate pasteurization steps are well known in the art of food manufacturing and can be undertaken at a variety of temperatures and for a variety of time durations as required by the instant application. In at least one embodiment, the liquid fraction recovered from the aforementioned methods is pasteurized in order to destroy harmful bacteria yet maintain the integrity of enzymes found in the liquid fraction. A wide variety of pasteurization processes are contemplated for use in connection with the present invention. In at least one embodiment, Ultra High Pasteurization (UHT) is employed, however other methods of pasteurization are also contemplated depending on the needs of the instant application of the present invention.

In another embodiment, the liquid fraction described above is blended with a plurality of other dehydrated ingredients. In another embodiment, the liquid fraction is further spray dried. In another embodiment the liquid or spray dried fraction is blended with other current infant formulations, or other ingredients commonly used in the art. In another embodiment, the powder is mixed with water for use as an infant or toddler formula, or is used as a protein supplement for children and adults.

It is further contemplated that the present oil-seed based food product formulation may be used as a nutritional additive to existing food products, or alternatively can be used on its own as a stand-alone food product. Existing food products contemplated for use in connection with the present invention include, but are not limited to, milk powders, dairy products, processed cereals, frozen meals and confectionaries, prepackaged beverages, and snack foods, baby foods, among any other suitable food product that will be readily understood by the skilled person.

It is contemplated that in some embodiments the above-described steps of blending, mixing, separation, dehydration, and crushing, among other process steps, may be optionally repeated multiple times in order to achieve an oil seed-based food product formulation that has the desired properties for the instant application. For example, in at least one embodiment, the oil seed may be soaked, mixed with water, blended (e.g. in a high speed blender), separated into liquid and solid fractions using a centrifuge, (or alternatively a nut press), dehydrated using spray-drying techniques, and then may be further crushed to result in a fine powder.

In another embodiment the liquid fraction is combined with other base ingredients, providing a liquid composition integrating all of the nutrients of the finished formulation. The final composition is spray dried at a high temperature air flow. This is used to achieve superior homogeneity and physical functionalities such as solubility, stability and dissolution.

When the methods of the present invention are employed, a product can be obtained with desirable properties of the resulting powder, including appearance, bulk density and flow ability, suitable for infant formulas and the like.

Formulations of the present invention, prepared using methods of the present invention, can also be used for sports, clinical and special needs applications, with exclusively hemp protein content.

In another embodiment of the present invention the raw materials can be in either liquid or powder form. In one embodiment all the ingredient bases are blended together in a clean water and/or milk solution.

In addition, depending on the ingredients and composition of the pre-mix, it is in certain embodiments possible to evaporate the contents to final solids prior to spray drying.

In another embodiment, the composition may consist of hemp protein isolate, water, sweeteners, lipids, fibers, vitamins and minerals. The combined formulation, in liquid form, may go through a mixing stage, a pre-treating stage, and a cooling stage resulting in a homogenous liquid. The homogenous liquid then goes through a pre-heating stage, a concentration stage or evaporation stage, a heat treatment stage, a homogenization stage, and finally a spray drying stage resulting in a nutritionally dense hemp based powder.

Following this, the fine powder may be blended with water and mixed, separated and dehydrated a second time to result in a dehydrated oil seed-based food product formulation that has desirable properties for a particular application. Alternatively, the fine powder may be mixed with other nutritional additives, rehydrated and then packaged as a liquid oil seed-based food product formulation as will be discussed in further detail both above and below, among other arrangements that will be readily understood by the skilled person. In another embodiment, any of the powder formulations described above is used as a protein supplement for children or adults, as a base for nutrient dense baked goods, as an all purpose flour for baking, or it can be added to pureed baby foods or cereals.

In another embodiment, the powder formulations described above can be mixed with one or more flavours, including but not limited to, vanilla bean, choca-maca and assorted fruit flavours.

In another embodiment of the invention, the formulations described above may provide a variety of caloric densities depending on the particular needs of the user, such as specialty formulations for pre term infants, toddlers/children, or adults.

In another embodiment, the liquid formulations described above can be frozen for use as frozen treats for toddlers or children, or as frozen soothers for teething.

The liquid or powder formulations described above are packaged in a number of different ways. In one embodiment, the liquid formulation is packaged in pre-sterilized containers, including but not limited to Tetrapak, shelf stable containers such as brick, gable top, liquid aseptic packaging, roll fed liquid aseptic packaging and single serve juice boxes. In at least one embodiment, the boxes are sterilized seconds before the liquid is added thus killing unhealthy bacteria that might enter the container.

In another embodiment of the invention, the liquid or powder formulation is packaged into heat resistant and light resistant containers for shelf-life stability.

### Analysis of Hemp as a Base Formulation in an Infant Formula

### Advantages of Hemp

Hemp provides all of the amino acids, essential fatty acids and protein necessary for proper growth and development of growing children and pregnant/nursing women. It is a dense source of trace minerals. There are no known allergies to hemp, and hemp is more digestible then dairy or soy which makes the product suitable for premature infants, infants with allergies, digestive issues as well as parents who prefer a vegetarian option for breastmilk supplementation. Hemp requires minimal processing compared to other infant formula bases, which keeps the nutrients and enzymes intact and is very important in an ideal breastmilk substitute. Hemp is free of estrogens, is more digestible, is hypoallergenic, requires no fertilizers, pesticides, and can grow ire almost any climate. Hemp is GMO-free. As a crop it has many benefits to soil propagation and can be grown in fields as a rotation crop providing additional income to farmers and benefiting the environment at the same time. Every part of the plant is usable from seed, to leaf, to stalk.

Hemp has been used in many ancient societies as a medicine and food, and is recommended by the World Health Organization as a part of a balanced diet for children ages 2-6. The World Association of Perinatal Medicine, the Early Nutrition Academy, and the Child Health Foundation recommend that pregnant and lactating women consume an average of at least 200 mg DHA daily, (Koletzko B, Lien E, Agostoni C, et al. The roles of long-chain polyunsaturated fatty acids in pregnancy, lactation and infancy: review of current knowledge and consensus recommendations. J Perinat Med. 2008; 36(1):5-14) Hemp is an excellent source of ALA, which converts to DHA in the body.

Approximately 44% of the weight of hempseed is edible oils, containing about 80% essential fatty acids (EFAs); e.g., linoleic acid, omega-6 (LA, 55%), alpha-linolenic acid, omega-3 (ALA, 22%), in addition to gamma-linolenic acid, omega-6 (GLA, 1-4%) and stearidonic acid, omega-3 (SDA, 0-2%). Proteins (including edestin) are the other major component (33%), second only to soy (35%).

### Essential Fatty Acid Content of Hemp

Hemp is a rich source of EFAs, about 80% (essential fatty acids) which are comprised of omega 3, 6 and 9 groupings, EFAs are essential for proper development, function and healing of all tissues and organs and the maintenance of all the body's systems. The Omega 3 group consists of the essential fatty acid ALA (Alpha linoleic Acid) which cannot be manufactured by the body and must be obtained in the diet. ALA can be converted to EPA (eicosapentaenoic acid) and MIA (docosahexaenoic acid) in healthy bodies, but there are some conditions that render this process insufficient. The Omega 6 grouping consists of LA (linoleic acid) which can be converted to AA (arachidonic acid) and DULA (dihomo-gamma-linoleic acid). Together, omega 3 and omega 6 groups are polyunsaturated fatty acids (PUFA). Current research suggests that the ideal ratio of omega 3 to 6 be a 3:1, where the typical Western diet tends to be a much higher level of omega 6 and much lower ratio of omega 3. A large body of research suggests that increasing the omega 3 fatty acids and decreasing the omega 6 fatty acids may have a number of benefits.

EFA deficiency is linked to many diseases and disorders, including but not limited to:
ADD, ADHD, Autism spectrum disorder including Asperger's, depression, dyslexia, dyspraxia;
poor vision;
inflammation of various tissues;
chronic Fatigue Syndrome;
Alzheimer's;
dementia; and
epilepsy and depression.

### Lipoic Acid/Alpha-Lipoic Acid Content of Hemp

Hemp seed contains about 55% LA (lipoic acid) and 22% ALA (alpha-lipoic acid). ALA LA are powerful anti-oxidants. Many studies have been conducted to show that free radicals found in food, water and our environment cause oxidative reactions in the cells resulting in many degenerative diseases such as cancer, Alzheimer's, Parkinson's, diabetes, heart diseases, arthritis, and neurological diseases such as ADD/ADHD and possibly Autism. Anti-oxidants have been shown in many studies to halt and even reverse damage to the cells caused by free-radical damage. This indicates that a diet rich in anti-oxidants can slow or even prohibit the development of oxidative diseases. High doses of ALA is currently used to treat diabetic conditions as well as some neurodegenerative diseases. Recent research indicates that LA has neuro-protective implications and can be used in prevention of DNA strand breakage due to free radical damage. The most common source of ALA and LA is fatty fish and fish oils, which provide an abundant source of DHA. However, in recent years there has been significant research and media concern over the use of fish oil as a supplement. Some of the concerns have been the findings of toxic substances found in fish oil which has resulted in physicians no longer recommending the use of fish oil by pregnant and lactating mothers or to children. Additionally there is increasing environmental concern regarding the over-harvesting of fish and the industry's negative impact on several aquatic species. Hemp is an excellent source of omega 3s, providing the necessary precursors to DHA and has many environmental benefits.

### Gama-Linoleic Acid Content of Hemp

Hemp consists of approximately 1-3% GLA (gama-linoleic acid). Also known as PUFAs, or polyunsaturated fatty acids, GLA are considered necessary for proper growth and development of all tissues and organs. In a healthy body, ALA and LA can be converted into GLA, but dietary sources of GLA are helpful for those with compromised immune systems, diseases or for pregnant and lactating women as women in this group require more GLA, ALA and LA. GLA is most known for its anti-inflammatory properties.

### Protein Content of Hemp

Hemp is about 33% protein and second only in protein content to soy. However, recent studies have indicated that hemp is a better overall source of protein. This can be concluded because hemp has a more balanced amino acid profile. It contains the ideal balance of omega 3 and 6, has higher digestive absorbability, and there are no known allergies to hemp. Most notably, hemp is approximately 65% edistin and 33% albumin. Edistin and albumin are globular proteins. Globular proteins are necessary for manufacturing and maintenance of all enzymes, antibodies, many hormones, hemoglobin and fibrogen. Globulins also makeup the fluid aspect of blood. Albumin is a foetal plasma protein that is water soluble. It is responsible for dispersing substances evenly throughout the blood stream while binding fatty acids, cations and bilirubin to the needed components throughout the body. Out of all plant and animal protein sources hemp is the only source that contains all 21 amino acids, and the only source with perfectly balanced omega 3 and 6 for human development and optimal health.

In summary, some of the notable benefits of hemp protein are as follows:
only protein source containing all 21 amino acids, and all 9 essential amino acids;
is second to soy for highest protein content, but is more absorbable and digestible;
contains 65% Edistin which is necessary for manufacturing and maintenance of all enzymes, antibodies, many hormones, hemoglobin and fibrogen;
contains 35% albumin, which is a globular protein in foetal plasma;
is non allergenic, and easily digestible;
is high in vitamins and minerals including: vitamins A, B1, B2, B6, C, D, and E;
is an adequate source of dietary fiber, calcium, iron;
is a good source of phosphorus, magnesium, zinc, copper and manganese; and
is a good source of chlorophyll,
   Comparison of Hemp with Existing Bases for Infant Formula

Currently there are five popular base options for infant formula. These include dairy, soy, goat milk, rice and hydrolyzed protein. As provided herein, the use of hemp as an infant formula base is, at least in certain embodiments, more beneficial to infant health. A hemp base may also be added, in other embodiments, to other formula bases to increase the nutritional, digestive, and taste quality,

### Soy Formulations

Soy is the highest source of bioavailable protein. Soy has about 35% usable protein, wheras hemp is about 33%, rendering hemp the second most bioavailable protein source. However, hemp is more digestible and absorbable than soy. Therefore, hemp as described herein is believed to be a better source of protein then soy for infant formula. Soy also contains ogliosaccharides, which can cause stomach upset, bloating and gas. In addition, soy contains trypsin inhibitors that block the absorption of protein and can cause kidney toxicity. Soy has further been shown to increase estrogen production in female and male infants, leading to hormonal imbalances. Organic soy is a better option for infant formula than non-organic soy. Studies have shown that ingestion of non-organic soy produced enlarged pancreases in mice and pancreatic adenoma and carcinoma in the rat. Conventionally grown soy is almost entirely a GMO crop, which are not currently permitted in most EU countries. Studies have also indicated massive destruction to plant and animal genetics from GM products.

Hemp contains all EFAs, amino acids and proteins appropriate for human growth. Hemp does not cause allergic reaction, stomach upset, gas or bloating because the amino acid and EFAs are in the ideal balance for absorption. Due to the higher digestibility of hemp than soy and the protein content of 65% edistins and 33% albumin, hemp is a better quality protein then soy for human consumption. However, many parents may still choose to use soy infant formula and therefore it is contemplated that hemp base added to soy based infant formula would increase the nutritional density and digestibility of soy, enhance the absorption properties, add ideal ratios of EFAs, would lessen the amount of estrogen in soy formulations and provide better taste. It is also contemplated that hemp based infant formula could completely replace the use of soy as an infant formula base,

### Dairy Formulations

Hemp has all of the health benefits of dairy based formulas without any of the side effects and allergies that many children experience from dairy infant formula consumption. Hemp is inexpensive to produce and benefits the environment, while dairy milk is very expensive, time consuming and environmentally taxing. A single dairy cow will consume 95 to 100 liters of water per clay, and eat 75-100 lbs. of feed per day. This is enough food and water to feed 10 people per day and provide clean water to 50 people daily. A single heifer to pasture requires four acres of grazing land. By contrast, 4 acres of hemp produces 128,000 lbs. of seed, whereas a single dairy cow will produce approximately 19,826 lbs. of milk per year. The entire hemp crop is useful for various industrial products. It takes 2.5 years for a dairy cow to mature, while hemp matures in four months. One cup of milk has 7-8 grams of protein, whereas 3 tablespoons of hemp seed contain 11 grams of protein. Thus, 2 oz. of hemp seed will produce 16 oz. of hemp beverage containing 3-4 grams more protein than 16 oz. of dairy milk. A hemp crop can turn over 8 rotations before a single dairy cow can mature in temperate climates. Non-organic dairy cattle are vaccinated and are given hormones to increase their milk production. The vaccines and hormones are passed into the milk and then consumed by humans and have been linked to a myriad of diseases in humans. Bovine vaccines are a contributing factor to the increase of vaccine-resistant superbugs. Hemp fields require no pesticides, herbicides, vaccines or hormones. Hemp plants grow a deep tap root and draw water from deep within the earth, thus reducing the overall demand for clean water resources. Hemp also requires 0 to very moderate fertilizer. It is considered that a dairy base blended with a hemp base for infant formula would have both economical and health benefits.

### Hydrolyzed Protein Formulations

Hydrolyzed protein was developed to provide a more digestible protein to premature infants and infants with a compromised ability to absorb dairy or soy based formulas. Hydrolyzation is a process in which the proteins are broken down into smaller protein chains, rendering the protein more digestible. Currently any infant formula labeled “hypoallergenic” has been completely hydrolyzed. Due to the extreme processing of these formulations there are no naturally retained enzymes or nutrients—these must be added, together with a great deal of sweetener (+40%) to remedy the unpalatable taste. Parents often comment that the smell of hydrolyzed protein formulations is poor, and that infants' bowel movements have an equally terrible order. Currently, the most widely used sweeteners for hypoallergenic formulations are corn syrup solid or high fructose corn syrup. Having to offset the taste of highly processed infant formulas with 40%+corn syrup or high fructose corn syrup has had devastating effects on childrens' health. One study found a strong correlation between obesity, heart disease and diabetes and infant formula consumption. Hemp used as a base has the benefit of providing a hypoallergenic protein that is easily digestible, without the need for high processing or added sweetener.

### Goat Milk Formulations

Goat milk based infant formula is considered more digestible than either dairy or soy and has a lower saturated fat content than dairy milk. However, goat milk is not hypoallergenic and some children do not enjoy the taste or smell, which is described as “gamey”. Due to the smell and taste, goat milk has not been as popular as a base for infant formula as dairy or soy. Hemp has a naturally sweet, nutty flavor with a rich, fatty palette, much like breast milk, and which many people find pleasant. The natural sweetness and richness of the hemp base requires less sweetener than other formulations, and is more palatable than soy, hydrolyzed protein, or goat based formulations. It is contemplated that, in certain embodiments, hemp could also be added to goat based infant formulas to improve the taste and nutritional profile.

### Rice Protein Formulations

Rice protein based formulations are considered a hypoallergenic alternative to soy or dairy. Rice is a main food stay and source of protein in many countries. However, these formulations require fortification with the amino acids lysine and threonine. Also, they do not have a complete fatty acid profile and must therefore be fortified with omega 3s and 6s. Rice protein bases are not as popular as dairy or soy. It is contemplated that, in certain embodiments, hemp could also be added to rice formulations to supply the full spectrum of amino acids and EFAs without having to fortify with hydrolyzed or isolated ingredients.

### Ingredients and Additives to Hemp Based Formulations

The following are some of the possible ingredients and additives to a hemp based formula as described herein.

Protein sources: spirulina, Aphanizomenon flos-aquae (AFA; blue-green algae), dairy, whey, skim milk, goat milk, rice protein, soy protein, hydrolyzed proteins, pea protein (specifically yellow pea protein), clary sage, and all other protein sources as would be known to those in the art.

Lipid sources: coconut oil, hemp oil, vegetable oil, fish oil, docosahexaenoic acid (DHA)/arachidonic acid (AA or sometimes ARA), as well as all other lipid sources as would be known to those in the art.

Carbohydrate sources: coconut palm sugar, palm sugar, coconut sap crystals, agave, succant, xylatol/wood sugar, yacon, as well as all other carbohydrate sources as would be known to those in the art.

Vitamins/Minerals: whole food based vitamin and mineral blend as well as all other vitamin and mineral sources as would be known to those in the art.

Of particular interest to the present invention are the ingredients of spirulina, blue-green algae (AFA), coconut palm sugar and whole food vitamins, which are not currently used in infant formula.

### Medical Benefits of Spirulina:

Spirulina is an excellent source of essential fatty acids including DHA which many studies indicate are important for optimal development of fetuses, to support healthy pregnancy and lactation. Spirulina's lipid content is about 7% by weight, and is rich in gamma-linolenic acid (GLA), and also provides alphalinolenic acid (ALA), linoleic acid (LA), stearidonic acid (SDA), eicosapentaenoic acid (EPA), docosahexaenoic acid (DHA) and arachidonic acid (AA or ARA). Spirulina contains vitamins B1 (thiamine), B2 (riboflavin), B3 (nicotinamide), B6 (pyridoxine), B9 (folic acid), vitamin C, vitamin D, vitamin A and vitamin E. It is also a source of potassium, calcium, chromium, copper, iron, magnesium, manganese, phosphorus, selenium, sodium and zinc, Spirulina contains many pigments which may be beneficial and bioavailable, including beta-carotene, zeaxanthin, chlorophyll-a, xanthophyll, echinenone, myxoxanthophyll, canthaxanthin, diatoxantbin, 3′-hydroxyechinenone, beta-cryptoxanthin and oscillaxanthin, plus the phycobiliproteins c-phycocyanin andallophycocyanin. The nutritional information for dried spirulina is shown below.

Spirulina (dried) Nutritional value per 100 g (3.5 oz):

| | | |
|---|---|---|
| Energy | 1,213 | kJ (290 kcal) |
| Carbohydrates | 23.9 | g |
| Sugars | 3.1 | g |
| Dietary fiber | 3.6 | g |
| Fat | 7.72 | g |
| Saturated | 2.65 | g |
| Monounsaturated | 0.675 | g |
| Polyunsaturated | 2.08 | g |
| Protein | 57.47 | g |
| Tryptophan | 0.929 | g |
| Threonine | 2.97 | g |
| Isoleucine | 3.209 | g |
| Leucine | 4.947 | g |
| Lysine | 3.025 | g |
| Methionine | 1.149 | g |
| Cystine | 0.662 | g |
| Phenylalanine | 2.777 | g |
| Tyrosine | 2.584 | g |
| Valine | 3.512 | g |
| Arginine | 4.147 | g |
| Histidine | 1.085 | g |
| Alanine | 4.515 | g |
| Aspartic acid | 5.793 | g |
| Glutamic acid | 8.386 | g |
| Glycine | 3.099 | g |
| Proline | 2.382 | g |
| Serine | 2.998 | g |
| Water | 4.68 | g |
| Vitamin A equiv. | 29 | μg (4%) |
| beta-carotene | 342 | μg (3%) |
| lutein and zeaxanthin | 0 | μg |
| Thiamine (vit. B1) | 2.38 | mg (207%) |
| Riboflavin (vit. B2) | 3.67 | mg (306%) |
| Niacin (vit. B3) | 12.82 | mg (85%) |
| Pantothenic acid (B5) | 3.48 | mg (70%) |
| Vitamin B6 | 0.364 | mg (28%) |
| Folate (vit. B9) | 94 | μg (24%) |
| Vitamin B12 | 0 | μg (0%) |
| Choline | 66 | mg (13%) |
| Vitamin C | 10.1 | mg (12%) |
| Vitamin D | 0 | IU (0%) |
| Vitamin E | 5 | mg (33%) |
| Vitamin K | 25.5 | μg (24%) |
| Calcium | 120 | mg (12%) |
| Iron | 28.5 | mg (219%) |
| Magnesium | 195 | mg (55%) |
| Manganese | 1.9 | mg (90%) |
| Phosphorus | 118 | mg (17%) |
| Potassium | 1363 | mg (29%) |
| Sodium | 1048 | mg (70%) |
| Zinc | 2 | mg (21%) |

Percentages are relative to US recommendations for adults. Source: USDA Nutrient Database.

Medical Benefits of AF A (Blue Green Algae):

AFA is a significant source of plant based DHA. There are two species of AFA blue green algae, most are toxic to humans with the exception of Klamath Lake Organic Blue Green Algae. This species is unique and has many benefits to human health. Klamath Lake Blue Green Algae has all 8 essential amino acids, 12 vitamins, 27 naturally occurring or essential minerals, and 11 pigments some of which are precursors to other vitamins, enzymes and co-enzymes. Along with beta-carotene, AFA also contains bioflavirioids, RNA, superoxide dismutase, catalase, glutathione, selenium, and cysteine, making AFA one of the highest known sources of naturally occurring anti-oxidants or free radical scavengers. AFA contains a full spectrum of vitamins, unusually complete for any single food. It is rich in B Vitamins, and contains the highest vegetable source of Vitamin B-12 and beta-carotene. Two grams of AFA provide an equal amount of beta carotene to 80 grams of carrots, 1200 grams of iceberg lettuce, four tomatoes, or four cooked eggs. The nutritional information for AFA is shown below.

Essential Amino Acid Composition:

| | | |
|---|---|---|
| Isoleucine | 29 | mg |
| Leucine | 52 | mg |
| Lysine | 35 | mg |
| Methionine | 7 | mg |
| Phenylalanine | 25 | mg |
| Threonine | 33 | mg |
| Tryptophan | 7 | mg |
| Valine | 32 | mg |

Semi-Essential Amino Acid Composition:

| | | |
|---|---|---|
| Arginine | 38 | mg |
| Histidine | 9 | mg |

Vitamin Composition Per Gram of Algae:

| | | |
|---|---|---|
| Provitamin A Beta Carotene | 2260 | IU |
| Thiamine B1 | 40 | mcg |
| Riboflavin B2 | 6 | mcg |
| Pyridoxine B6 | 13 | mcg |
| Cobalamin B12 | 6 | mcg |
| Ascorbic Acid C | 6 | mg |
| Niacin | 130 | mcg |
| Folic Acid | 1.0 | mcg |
| Choline | 2 | mg |
| Pantothenic Acid B5 | 8 | mcg |
| Biotin | 0.3 | mcg |
| Vitamin E | 0.2 | IU |

Mineral Composition Per Gram of Algae:

| | | |
|---|---|---|
| Boron | 10 | mcg |
| Calcium | 7 | mg |
| Chlorine | 464 | mcg |
| Chromium | 0.51 | mcg |
| Cobalt | 2.0 | mcg |
| Copper | 4.0 | mcg |
| Fluorine | 38.0 | mcg |
| Germanium | 0.27 | mcg |
| Iodine | 7 | mcg |
| Iron | 410 | mcg |
| Magnesium | 2.0 | mg |
| Manganese | 20 | mcg |
| Molybdenum | 3.3 | mcg |
| Nickel | .3 | mcg |
| Phosphorus | 5.1 | mcg |
| Potassium | 17 | mg |
| Selenium | 0.7 | mcg |
| Silicon | 186.7 | mcg |
| Sodium | 2.7 | mg |
| Titanium | 23 | mcg |
| Vanadium | 2.7 | mcg |
| Zinc | 10 | mcg |

Fatty Acid Composition:

| | | |
|---|---|---|
| Palmitic | (16:0) | 43.4 |
| Palmitoleic | (16:1) | 9.7 |
| Palmitolinoleic | (16:2) | Trace |
| Stearic | (18:) | 2.9 |
| Oleic | (18:2) | 2.9 |
| Linoleic | (18:2) | 12.4 |
| Linoleic 6,9,12 | (18:3) | 21.4 |

Chemical Composition (Component % of Total):

| Protein | up to 70 |
|---|---|
| Carbohydrates | 21 |
| Minerals | 4 |
| Lipids | 2 |
| Chlorophyll | 3 |

Studies have indicated that DHA is important for proper development of the fetus during pregnancy, proper visual and brain development in infants and children. DHA also supports healthy, longer term pregnancy as well as healthy lactation. DHA from fish oil or algal oil are currently the most common sources used in infant formulations and recommended to pregnant and nursing mothers. However, recent studies indicate that due to allergies to fish and high levels of mercury contamination in fish oil products many doctors are no longer recommending fish oil to pregnant women and children. Algal oil is a typical source of DHA and EPA in infant formulas. However, extraction methods using toxic compounds such as hexane have caused harm to infants and a pull back by industry to continue to use this product. APA is an excellent alternative to fish oil and algal oil. It is a significant source of DHA, is easily digested, is free of heavy metals and toxins and requires no chemical extraction method.

AFA is an excellent source of plant based DHA/EPA. It does not require harsh chemical extraction as in algal oil, and does not contain toxic heavy metals as in fish oil, is a vegetarian source and is easily assimilated. Therefore AFA, is an ideal source for DHA/EPA in infant formula,

### Medical Benefits of Coconut Palm Sugar:

As described herein, coconut palm sugar can be used as a replacement for other carbohydrate sources and sweeteners typically used in the art.

Recent studies indicate the great need for a new, healthier carbohydrate source for infant formulations. Current sources include sucrose, maltodextrin, dextrin, glucose, fructose, lactose, corn syrup, corn syrup solids, high fructose corn syrup and brown rice sugar. All of the above have a high glycemic index due to the high processing extraction methods and have been proven to cause a myriad of illnesses and diseases in children and adults including but not limited to allergies, diabetes, cancer, ADD/AMID, cardiovascular disease, hypoglycemia, obesity, and many others. Coconut palm sugar has been a staple in some traditions for 6,000 years. The Food and Agriculture Organization of the United Nations (FAO) has reported that coconut palm sugar is likely to be the world's most sustainable sweetener. With an extremely low glycemic index, an extremely high nutrient content and an affordable price for manufacturers and consumers alike, palm sugar is poised to become a leading sustainable sweetener.

The following is a comparison of the macro-nutrients of coconut palm sugar to other popular sweeteners:

| Macro-nutrients | Coconut | Agave | | Maple | Brown | Refined White |
|---|---|---|---|---|---|---|
| (mg/100 gm) | Palm Sugar | Syrup | Honey | Syrup | Sugar | Corn Syrup Sugar |
| Nitrogen (N) | 202 | NA | NA | NA | 10 | 0 |
| Phosphorus (P) | 79 | 7 | 4 | 2 | 3 | 0 |
| Potassium (K) | 1,030 | 1 | 52 | 234 | 65 | 2.5 |
| Calcium (Ca) | 8 | 1.5 | 6 | 67 | 24 | 6 |
| Magnesium (Mg) | 29 | 1 | 2 | 14 | 7 | 1 |
| Sodium (Na) | 45 | 1 | 4 | 9 | 2 | 1 |
| Chloride (Cl) | 470 | NA | NA | NA | 16 | 10 |
| Sulfur (S) | 26 | NA | NA | NA | 13 | 2 |
| Boron (B) | 0.6 | NA | NA | NA | 0 | |
| Zinc (Zn) | 2 | 0.2 | 0.2 | 4.2 | .2 | 0.1 |
| Manganese (Mn) | 0.1 | 0.1 | 0.1 | 3.3 | .2 | 0 |
| Iron (Fe) | 2 | 1 | 0.4 | 1.2 | 1.26 | 0.1 |
| Copper (Cu) | 0.23 | 0.1 | 0 | 0.1 | 0 | 0 |
| Thiamine | 0.41 | 0 | 0 | 0 | 0 | 0 |
| Vitamin C | 23.4 | 0.5 | 0.5 | 0 | 0 | 0 |

Source: The Philippine Food and Nutrition Research Institute, COMPARISON OF THE ELEMENTAL CONTENT OF 3 SOURCES OF EDIBLE SUGAR—Analyzed by PCA-TAL, Sept. 11, 2000. (MI Secretaria et al, 2003) in parts per million (ppm or mg/li), USDA,www.nutritionaldata.com.

The following is a list of health attributes associated with the macro-nutrients found in coconut palm sugar:

| Macronutrient | Health benefits provided |
|---|---|
| Nitrogen (N) | help treat cardiovascular diseases |
| Phosphorus (P) | important for bone growth, kidney function and cell |
| | growth |
| Potassium (K) | reduces hypertension, helps regulate blood sugar, |
| | helps control cholesterol levels and weight |
| Calcium (Ca) | important for strong bone and teeth, and for muscle |
| | growth |
| Magnesium (Mg) | essential for metabolism, nerves and stimulates the |
| | brain (memory) |
| Sodium (Na) | plays a key role in the functioning of nerves and |
| | muscles |
| Chloride (Cl) | corrects the pressure of body fluids and balance the |
| | nervous system |
| Sulfur (S) | important for healthy hair, skin and nails, also |
| | helps maintain oxygen balance for proper brain |
| | function. |
| Boron (B) | essential for healthy bone and joint function, |
| | enhances body's ability to absorb calcium and |
| | magnesium |
| Zinc (Zn) | called the “nutrient of intelligence” - is |
| | necessary for mental development |
| Manganese (Mn) | has antioxidant, free-radical-fighting properties, |
| | and is important for proper food digestion and for |
| | normal bone structure |
| Iron (Fe) | important for the quality of blood, mental |
| | development and the immune system |
| Copper (Cu) | helps to release energy, helps in melanin production |
| | in the skin, helps in the production of red blood |
| | cells and aids in the absorption and transport of |
| | iron. |

Coconut palm sugar is made from the nectar produced from the coconut tree (Cocos nucifera). Once collected, it is boiled and processed into a granule. As such it is a simple process, and a very simple and pure product. Coconut palm sugars produce slow release energy, which sustains the human body through daily activities without sugar “highs” and “lows”.

Coconut palm sugar is naturally low on the Glycemic Index (GI), which has benefits for weight control and improving glucose and lipid levels in people with diabetes (type 1 and type 2). Coconut palm sugars are rated as a GI 33-35. By comparison, most commercial agaves are GI 42, honeys are GI 55 and cane sugars are GI 68. Corn syrup has a GI rating over 55, and high-fructose corn syrup has a rating of 100. Studies have shown that introducing babies to solid food too soon significantly raises their chances of becoming obese.

It is also contemplated that several diseases in children such as allergies, ADD/ADHD, Autism, Asperger's, inflammation related diseases such as IBS and Crohn's, obesity, diabetes, depression, heart disease and even epilepsy, which have dietary indications in which typical sweetener options aggravate these conditions, would benefit from replacing these typical sweetners with coconut palm sugar.

Whole food Vitamins and Minerals

Natural and synthetic vitamins and minerals are commonly added to infant formulations to increase the nutritional content to and to closely match the nutritional composition of breast milk. The formulations described herein are nutritionally dense without the need for adding vitamins and minerals. These whole-food vitamin and mineral sources are superior to the “natural” and “synthetic” sources commonly used today.

Synthetic vitamins and minerals are made or processed with petroleum derivatives or hydrogenated sugars. Vitamins in food are not crystalline and never isolated, and are thus chemically structured differently. Synthetic vitamins lack the enzymes, coenzymes, minerals, mineral activators, and co-vitamin helpers that occur in natural sources. Some of these synthetic vitamins can also be very toxic due to their extraction methods. The side effects vary but include gastrointestinal diseases, neurotoxicity, vomiting, diarrhea, reproductive toxicity, allergic skin reactions, and some forms of cancer. “Natural” vitamins and minerals are isolated from plant and mineral sources, however they are still highly processed and lack the enzymes, coenzymes, mineral activators, and co-vitamin helpers required for full assimilation. Whole food vitamins and minerals are derived by dehydration or hydrosols preparation, which does not alter the plants' cellular structure. This full cellular structure is recognized by the body as food rather than an isolate, and is easily assimilated into the blood and tissues. For this reason, the use of whole-food vitamins and minerals is considered to be superior to synthetic and natural vitamins, and is preferred for the formulations described herein.

Infant formula, by definition, is a very complex formulation for the purpose of providing an infant with their only source of nutrients. Therefore the formulation, manufacturing, sterilization, and packaging of these products is highly regulated and requires a special license, regular inspections, and constant communications with health boards.

In addition, the blending stage in the preparation of an infant formula is important for incorporating the various ingredients into the liquid. The behavior of each ingredient must be considered for its heat sensitivity, solubility characteristics, reactions with other components, stirring conditions, and foam functionalities, resulting in a homogeneous solution containing all of the components of the finished product starting from a powder, solid, or syrup form.

To gain a better understanding of the invention described herein, the following examples are set forth. It will be understood that these examples are intended to describe illustrative embodiments of the invention and are not intended to limit the scope of the invention in any way.

### EXAMPLES

Provided below are examples of how the formulations are prepared and packaged.

### Example 1

The formulations can be used to prepare a nutrient dense hemp based baked product for consumption by toddlers, children or adults. Provided below, is an example of the method of preparing such a product.

The ingredients are blended in a high speed blender and the liquid is separated by way of an industrial press, centrifuge or sieve. The resulting cake is dehydrated and then blended into a fine powder. The powder can then be utilized as an all purpose flour for preparing a plurality of baked goods, such as cookies, bars, cereals and cakes.

The ingredients used in the above example may include, but are not limited to, hulled hemp seed, spring water, raw blended whole foods multivitamin/greens supplement, alphanizomenon-flos aquea (AFA), guar gum, whole coconut butter, coconut sap sugar and assorted flavorings.

### Example 2

Whole hemp seeds and almond are soaked in distilled water for eight hours. The hemp seed is then washed and added to a high speed blender with a plurality of other ingredients and blended into a slurry. The slurry is poured through a series of fine mesh strainers to separate the liquid and solids. The liquid is then packaged and ready for consumption. The solids are dehydrated and added to other dehydrated ingredients to make various food products, including but not limited to, cookies, and bars.

The ingredients used in the above example may include, but are not limited to, 50% whole hemp seed, 50% almonds, spring water, liquid multivitamin, Alphanizomenon-flos aquea, banana, and agave nectar.

### Example 3

Whole hemp seeds are soaked in distilled water for eight hours. The hemp seed is then washed and added to a high speed blender with a plurality of other ingredients and blended into a slurry. The slurry is poured through a series of fine mesh strainers to separate the liquid from a cake-like substance. The liquid is flash frozen into containers for shipping.

The ingredients may include, but are not limited to, whole hemp seeds, spring water, liquid multi vitamin, Alphanizomenon-flos aquea (AFA), iron, banana, agave nectar.

### Example 4

Hulled hemp seed and a plurality of other ingredients are blended in a high speed blender and the liquid is separated by way of industrial press and sieve. The resulting solid fraction is dehydrated and then crushed into a fine powder. The powder is then suitable as powdered baby formula for infants or toddlers or as a dehydrated protein supplement for infants/children/adults. The powder may also be further utilized as a base for nutrient dense cookies, snacks, bars, mixed into pureed baby foods, into cereals, or as a final all purpose flour for a healthy pre-boxed baking.

The ingredients may include but are not limited to hulled hemp seeds, spring water, raw blended whole foods multivitamin/greens supplement, Alphanizomenon-flos aquea (AFA), guar gum, whole coconut butter, coconut sap sugar.

### Example 5

The liquid formulations are flash-heated and packaged into various sizes of tetra pale containers for shelf stability, and ready-to-pour ease. This method can be utilized for various products including but not limited to infant and toddler formulas, drink boxes, for pre-natal nutrition beverages, lactation support beverages, or sports nutrition beverages.

### Example 6

The liquid formulations are flash-frozen, freeze-dried, and powdered into a shelf-stable powder product packaged in a heat resistant/light resistant container. This method can be utilized for various products including but not limited to the infant/toddler formula lines, the pre-natal supplement line, the lactation support line, the adult protein supplement line as well as in high end animal food products.

### Example 7

### Infant Formula Compositions

The following tables provide examples of hemp seed formulations comprising a total of 1%, 2.5% and 5% hulled hemp seed in various combinations of a dairy based infant formula. As can be seen, increasing the hemp seed composition while at the same time reducing the dairy content maintains each of the protein, fat and carbohydrate content of the formula within targets set by the FDA for nutritional content in infant formula.

Hemp seed-hulled

| | | | | | FDA targets per 100 kcal | | | |
|---|---|---|---|---|---|---|---|---|
| | | | In | | Minimum | | Maximum | |
| Ingredient | gr/per 100 gr | Nutrients | Formula | | Level | | Level | |
| dairy based 1% hemp in total | | | | | | | | |
| hemp seed | 1 | Protein | 4.4 | gr | 1.8 | gr | 4.5 | gr |
| whey pro con | 19 | Fat | 4.6 | gr | 3.3 | gr | 6 | gr |
| skim milk powder | 42 | Carbohydrate | 9.8 | gr | 9 | gr | 14 | gr |
| lactose | 19 | calories | 100 | kcal | | | | |
| Safflower oil, high linoleic | 19 | | | | | | | |
| dairy based 2.5 % hemp in total | | | | | | | | |
| hemp seed | 2.5 | Protein | 4.1 | gr | 1.8 | gr | 4.5 | gr |
| whey pro con | 19 | Fat | 4.6 | gr | 3.3 | gr | 6 | gr |
| skim milk powder | 40 | Carbohydrate | 9.8 | gr | 9 | gr | 14 | gr |
| lactose | 19.5 | calories | 100 | kcal | | | | |
| Safflower oil, high linoleic | 19 | | | | | | | |
| dairy based 5% hemp in total | | | | | | | | |
| hemp seed | 4.9 | Protein | 4.1 | gr | 1.8 | gr | 4.5 | gr |
| whey pro con | 19.5 | Fat | 4.6 | gr | 3.3 | gr | 6 | gr |
| skim milk powder | 36.6 | Carbohydrate | 9.8 | gr | 9 | gr | 14 | gr |
| lactose | 19.5 | calories | 100 | kcal | | | | |
| Safflower oil, high linoleic | 19.5 | | | | | | | |

Thus, hemp is so high in protein and has all of the required fats that a small amount may only be needed to meet FDA guidelines for an infant formula. For this reason, regardless if it used alone or added to another protein source such as dairy, it must be carefully balanced with the content of the other components of the formula to remain within recommended nutritional content limits. Hemp may in certain formulations be added in amounts up to about 4.5 grm/100 kcal. Lower amounts of hemp will typically be used if combined with another formula base, such as dairy or soy.

Variations of other possible hemp formulations are also shown below, including combinations with dairy and rice.

| | | FDA targets per 100 kcal | | | | | |
|---|---|---|---|---|---|---|---|
| | gr/per | | In | Minimum | | Maximum | |
| Ingredient | 100 gr | Nutrients | formula | level | | level | |
| Hemp seed-hulled dairy based | | | | | | | |
| hemp seed | 36.4 | Protein | 4.3 | 1.8 | gr | 4.5 | gr |
| whey pro con | 13.6 | Fat | 5.6 | 3.3 | gr | 6 | gr |
| skim milk powder | 13.6 | Carbohydrate | 9.4 | 9 | gr | 14 | gr |
| lactose | 27.3 | calories | 100 kcal | | | | |
| Safflower oil, | 9.1 | | | | | | |
| high linoleic | | | | | | | |
| Hemp seed-hulled non-dairy based | | | | | | | |
| hemp seed | 32.6 | Protein | 4.3 | 1.8 | gr | 4.5 | gr |
| rice concentrate | 9.3 | Fat | 5.7 | 3.3 | gr | 6 | gr |
| pea isolate | 4.7 | Carbohydrate | 9.3 | 9 | gr | 14 | gr |
| lactose | 41.8 | calories | 100 kcal | | | | |
| Safflower oil, | 11.6 | | | | | | |
| high linoleic | | | | | | | |

| | gr/per | | In | Minimum | | Maximum | |
|---|---|---|---|---|---|---|---|
| Ingredient | 100 gr | Nutrients | formula | level | | level | |
| Hemp Protein powder dairy based | | | | | | | |
| hemp powder | 30.0 | Protein | 4.1 | 1.8 | gr | 4.5 | gr |
| whey powder | 10.0 | Fat | 4.6 | 3.3 | gr | 6 | gr |
| milk protein | 5.0 | Carbohydrate | 9.8 | 9 | gr | 14 | gr |
| concentrate | | | | | | | |
| lactose | 35.0 | calories | 100 kcal | | | | |
| Safflower oil, | 20 | | | | | | |
| high linoleic | | | | | | | |
| Hemp Protein powder non-dairy based | | | | | | | |
| hemp powder | 28.6 | Protein | 4.3 | 1.8 | gr | 4.5 | gr |
| rice concentrate | 4.8 | Fat | 5.7 | 3.3 | gr | 6 | gr |
| pea isolate | 4.8 | Carbohydrate | 9.5 | 9 | gr | 14 | gr |
| lactose | 38 | calories | 100 kcal | | | | |
| Safflower oil, | 23.8 | | | | | | |
| high linoleic | | | | | | | |
| Hemp Protein isolate dairy based | | | | | | | |
| hemp isolate | 30.2 | Protein | 3 | 1.8 | gr | 4.5 | gr |
| whey powder | 7.5 | Fat | 3.6 | 3.3 | gr | 6 | gr |
| milk protein | 7.5 | Carbohydrate | 9.1 | 9 | gr | 14 | gr |
| concentrate | | | | | | | |
| lactose | 38.2 | calories | 100 kcal | | | | |
| Safflower oil, | 16.6 | | | | | | |
| high linoleic | | | | | | | |
| Hemp Protein isolate non-dairy based | | | | | | | |
| hemp isolate | 31.8 | Protein | 3.1 | 1.8 | gr | 4.5 | gr |
| rice concentrate | 9.1 | Fat | 4.4 | 3.3 | gr | 6 | gr |
| lactose | 40.9 | Carbohydrate | 9.2 | 9 | gr | 14 | gr |
| Safflower oil, | 18.2 | calories | 100 kcal | | | | |
| high linoleic | | | | | | | |

### Example 8

### Nutritional Composition of Hemp

Hemp seeds provide a “complete” protein profile. Hemp seeds contain all the essential amino acids that we need from our diet. This means that hemp products are excellent substitutes for animal products and animal based foods. These, too, are a good source of complete proteins, but they have the disadvantage of containing more omega 6 and omega 9 fats, which can unbalance the diet, attributing to disease.

### Composition of Hemp Seeds without Coating

| | % |
|---|---|
| LIPIDS | 46 |
| PROTEINS | 32 |
| GLUCIDES | 11 |
| ASH | 6 |
| WATER | 5 |

### Fatty Acid Profile of Hemp Seed Oil

| FATTY ACIDS | % |
|---|---|
| Poly unsaturated fatty acids | 80 |
| Linoleic acid | 55 |
| α Linolenic acid | 20 |
| γ Linolenic acid | 3 |
| Stearidonic acid | 1 |
| Mono unsaturated fatty acids | 11 |
| Oleic acid | 10 |
| Saturated fatty acids | 9 |
| Palmitic acid | 5 |
| Stearic acid | 3 |
| Arachidic acid | 1 |
| Essential fatty acids | 75 |
| ω6/ω3 | 3/1 |

### Amino Acids Profile

| Amino-acids | |
|---|---|
| | g/100 g of bean |
| Histidine | 0.9 |
| Isoleucine | 1.28 |
| Leucine | 2.18 |
| Lysine | 1.31 |
| Sulphured amino acids | 0.86 |
| Aromatic amino acids | 2.62 |
| Threonine | 1.6 |
| Tryptophane | 0.51 |
| Valine | 1.63 |
| | g/100 g of protein |
| Aspartic acid | 10.3 |
| Gultamic acid | 17.2 |
| Alanine | 4.8 |
| Arginine | 11.2 |
| Cysteine | 0.9 |
| Glycine | 4.3 |
| Histidine | 2.8 |
| Isoleucine | 4 |
| Leucine | 6.8 |
| Lysine | 4.1 |
| Methionine | 1.8 |
| Phenylalanine | 4.6 |
| Proline | 4.6 |
| Serine | 5.1 |
| Threonine | 5.0 |
| Tryptophane | 1.6 |
| Tyrosine | 3.6 |
| Valine | 5.1 |

### Example 9

### Processing of Main Raw Materials from Hemp

### Hemp Liquid and Hemp Protein Isolate

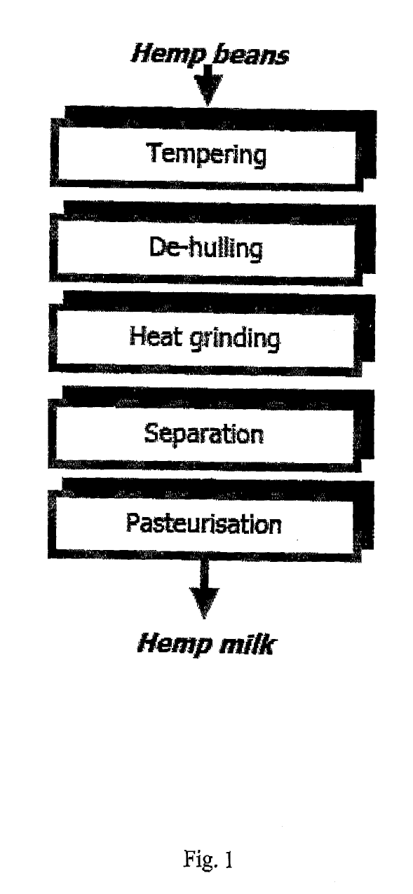

An example of a flow diagram for the production of hemp Liquid is shown in FIG. 1.

Hemp seeds are harvested, cleaned, hulled, and may optionally be pressure cooked to loosen the hull (pressure cooking is not required, but may in certain embodiments be desirable). Next, the cooked hemp seeds are ground by a number of grinders that transform the seeds into a milky shiny. The slurry is placed in a centrifuge that extracts any insoluble bits of seeds. The separated hemp liquid is the main raw material to make some hemp liquid products blended with vitamins, flavorings, and carbohydrates, dairy milk, additional amino acids and lipids and then sterilized and homogenized. The infant formula is cooled and packaged in such a way that it is never exposed to air for prepared liquid consumption.

Once the hemp seeds are harvested and brought to the plant, the seeds are cleaned in a grain elevator or bin on or off premises, using some clean water.

De-hulling: The hemp seeds may optionally be steamed and split in half. This loosens the hull on the seed. A vacuum sucks off the hulls.

Invalidating the indigestible enzyme: As an optional step, which is not required but may be used in certain embodiments, hemp seeds are cooked in order to invalidate, or counteract, a specific enzyme which makes them indigestible to humans. This cooking occurs in the Enzyme Invalidator, in which the de-hulled hemp seeds are cooked using high pressure, water, and high temperature (creating very hot live steam) to invalidate that enzyme.

Rough grinding: The (uncooked or cooked) hemp seeds then fall into the first rough grinder or mill. Water is added to the machine and the seed pieces are roughly ground in this first milling.

Finer grinding: Although they have been ground once, the cooked hemp seeds are still rather coarse. Thus, the fine grinder further pulverizes the bean pellets into small particles. The hot slurry is white in color with minuscule particles of insoluble hemp seed particles.

Extracting: A large centrifuge is then used to extract the tiny bits of hemp seed that are insoluble and cannot be included in the finished product. These particles are separated from the hemp slurry using a centrifuge. A rubber roller presses the hemp slurry against the surface of a drum within the centrifuge, forcing the liquid inside the drum while the fibers remain on the outside of the drum. The drum is then scraped of these fibers and remaining hulls. These hemp hulls and fibers are physically removed from the production process at this time. A separate process dries the waste fiber for use in other products such as baked goods, protein powder and animal feed.

The fiber-less hemp liquid is raw hemp liquid at this point and is pasteurised to make it stable (in particular microbiology) and can be blended with other ingredients.

### Typical Hemp Raw Milk Composition

| | g/100 ml |
|---|---|
| LIPIDS | 2.8-3.2 |
| PROTEINS | 0.7-1.1 |
| GLUCIDES | 0.3-0.5 |
| ASH | 0.3 |
| ENERGY | 28-35 kcal |

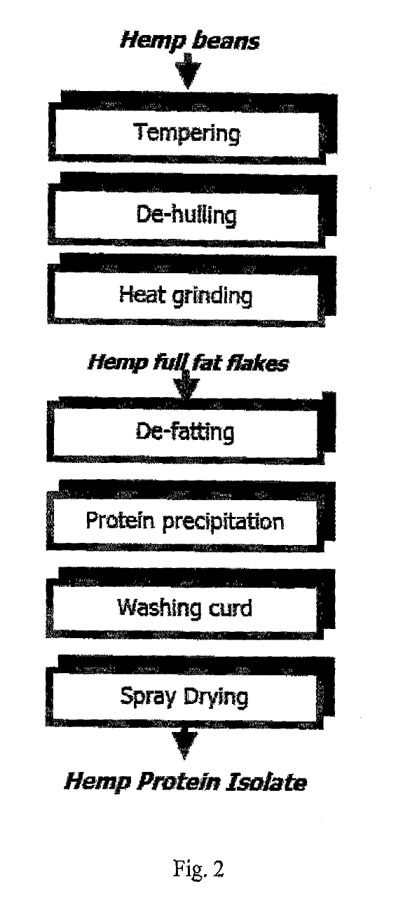

An example of a flow diagram for the production of hemp protein isolate is shown in FIG. 2.

Hemp protein isolate is the most concentrated form of low-fat, and high-protein nutrition currently available. The principles used in the production of hemp protein isolate are basically simple. Using defatted hemp flour or flakes as the starting material, the protein is first dissolved in water. The resulting solution is then separated from the solid residue. Finally, the protein is precipitated from the solution, and then separated and dried.

Protein extraction: The hemp meal is mixed with water and isoelectrically adjusted so that the majority of the protein goes into solution. This protein-rich solution must then be separated from the solid matter. A traditional configuration for doing this features extraction consisting of vibrating and rotary screens, followed by optional purification and concentration.

Protein precipitation: The protein solution is now isoelectrically adjusted still further so that the protein can be precipitated. The solidified protein (known as cake) must then be separated out.

Cake washing: The precipitated protein (cake) is separated from the supernatant (whey) using a decanter centrifuge. This cake must then be washed in order to remove any whey residues. Thorough washing is an important step in obtaining hemp protein isolate of high purity. The protein content in the product is now 90% or more (based on solids). The by-product from the extraction contains fibers and the remaining undissolved proteins. Depending on the final use of the hemp protein isolate—be it in fortified energy drinks, or in powdered infant formula/baby food—the protein solution can be pasteurized or UHT treated before.

Spray Drying: Hemp protein isolate is spray dried in a tower using atomization by high pressure nozzles and a high drying air temperature. The high protein content in the concentrate makes it very viscous. Low total solids content is then necessary in the feed and the resulting powder will consist of fine particles. To avoid powder loss, the process air is passed through bag filters. By selecting a fluidized spray dryer, it will be possible to produce an agglomerated free-flowing powder.

Processing of the by-products: The water used for soaking and extracting the hemp flakes contains carbohydrates and salts. The water is removed by evaporation and after condensation polished in a reverse osmosis plant. The water can now be used for cleaning purposes or returned to the extraction process thereby saving water. The concentrate with the carbohydrates and salts are mixed with the fiber/undissolved protein fraction from the extraction. This mixture is then dried in a Ring Dryer and used for animal feed.

Powder handling and packaging: Both SPI and by-products can be conveyed to silos and bagged off in suitable bags.

### Example 10

### Processing of Finished Products from Raw Hemp Milk or Hemp Protein Isolate

Processing of UHT Hemp from Hemp Milk:

Blending: Hemp liquid is injected into large tanks and flavorings, sugar, and vitamins are mixed separately in smaller tanks in case of formulated products from hemp milk base. Ingredients of the smaller tank are infused into the larger tanks, thus blending the flavors with the raw “milk”.

Aseptic sterilizing: At this point, it is essential that the hemp “milk” or liquid mix is sealed within the equipment until the end of the manufacturing process (including packaging) in order to keep out air and ambient bacteria and germs that can grow in low-acid hemp “milk”. Sterilization occurs with pressure and very hot temperatures within a vacuum for a short period of time.

Homogenizing: From the sterilizer, the hot “milk” is sent to the homogenizer. This breaks down the fat particles and prevents them from separating from the rest of the mixture. In the homogenizer, which is essentially a high-pressure piston pump, the hot “milk” is blended as it is drawn into the pump cylinder and then forced back out in a repetitive motion.

Cooling: Next, the hot “milk” is piped to the cooling tank. Here, the hot “milk” passes next to cold plates that lower the temperature of the hemp “milk” to room temperature.

Storing: The cooled “milk” is sent to the aseptic (sealed) tanks and held here in preparation for packaging. Here, the hemp “milk” is refrigerated, pressurized, and sealed to ensure no bacteria thrives in the “milk”.

Packaging: A very important part of the production is the aseptic packaging of the product. Packaging machines have been developed for this product that are able to mechanically package the product without exposing it to air. The cooled “milk” is sent to this packaging machine which has a ribbon of flat packaging (cardboard) threaded into it. As the milk runs through the machine, the packaging surrounds the “milk” and a cutter cuts through the cardboard packaging and the “milk”, simultaneously folding the package and sealing the milk within it. A machine glues a plastic spout onto the sealed package. From here, the product is sent to an automatic sorter that packs a case and places it on a pallet.

### Example 11

### Processing of Infant Formula Powders, and Powders for Other Specialty Uses

Nutritional powders dedicated to specific needs, such as infant formulas (also referred to as baby food) production requires the best in processing equipment to meet the strict requirements of product quality and hygiene that is required by health authorities. The composition of the product is one aspect—to meet the specific nutritional functionalities of the consumer—another is the powder properties—appearance and bulk density. This is of vital importance to obtain the right dosage, it is important to ensure that the product is instantly dissolved, e.g. in the water, leaving no lumps (e.g. which can block the sucking action).

Two main processes can be used to produce such nutritional powders:

Full spray drying: a liquid integrating all the nutrients of the finished formula is spray dried in a tower using high temperature air flow. This technology is used to reach the best homogeneity of the product and provide the best physical functionalities of the products (solubility, dissolution, etc.). Powders with high protein content have a very high affinity to water. During re-wetting, such powders dissolve so quickly that the particle surface instantly turns into a gel, which prevents further water penetration.

Dry blending: different bases of powders and/or powder ingredients are blended together in order to obtain a homogeneous product. This technology is currently used but is limited concerning the final specifications of the product.

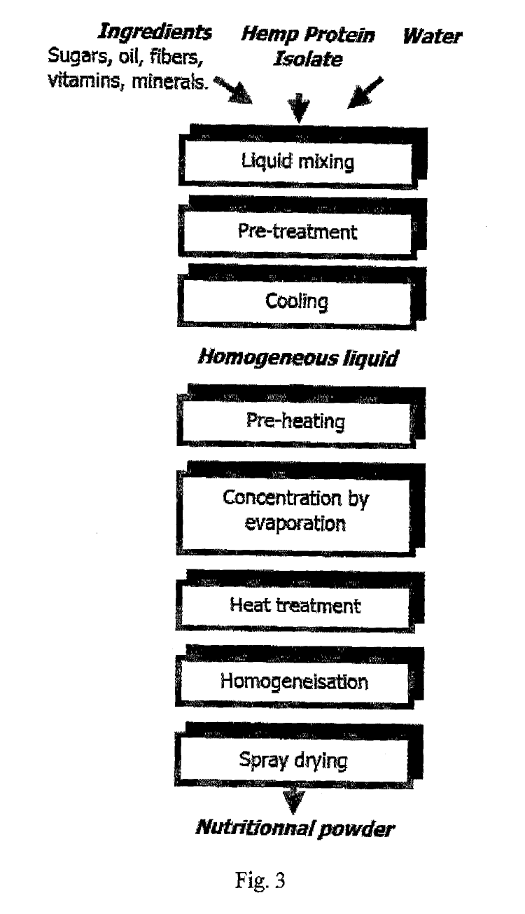

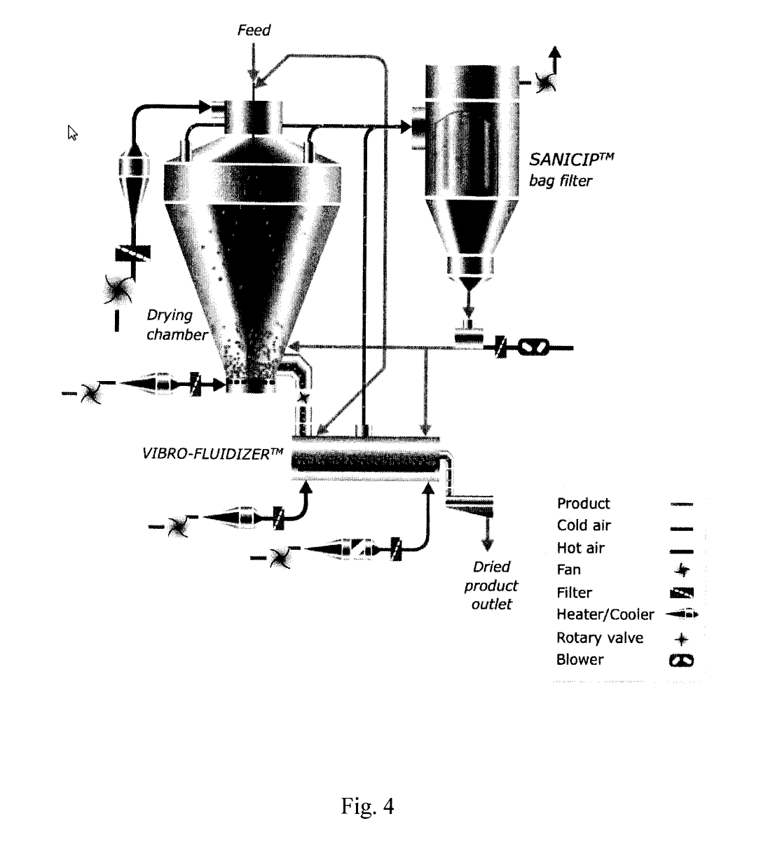

An example of a process for preparing the nutritional powder form is illustrated in FIG. 3. FIG. 4 illustrates a schematic diagram of an example of a spray drying system that can be used in the production a nutritional powder form.

Raw materials for the production of nutritional products may be either in powder form or a liquid such as oil or milk. All the ingredients bases are blended together in a liquid (clean water and/or milk). Depending on how the pre-mixing has been carried out and the composition of the pre-mix, it is possible to evaporate the concentrate to the final solids content before spray drying.

Raw materials reception, mixing and pre-treatment: The blending stage is very important as various ingredients can be incorporated into a liquid. Behaviour of each one has to be considered, such as heat sensitivity, solubility characteristics, reactions with other components, stirring conditions, foam functionalities, etc. The main target is to prepare a homogeneous solution including all the different components of the finished product, starting from powder ingredients, syrups and liquid forms. The order of incorporation of the different raw materials can in certain embodiments be important, to make possible the complete dissolution of each one while avoiding chemical reactions. Reducing the incorporation of air is also important for the further processing steps, as air changes the efficiency of the technologies impact. Main parameters to be considered are temperature, stirring conditions, acidity control, dry matter content, viscosity and mixing time. Once the product solution is well prepared, pasteurisation and flash cooling steps are used to reduce the microbiological growth and obtain a stable solution before next step.

Concentration by evaporation: Concentration by evaporation is a method of removing water by boiling. The steam, used as heat transfer fluid, gives up its latent heat to the product. To reduce biochemical damage, concentration by evaporation is carried out under a partial vacuum to reduce the processing temperature (between 40° C. and 80° C.). An evaporator is typically multi-stage type (called effect) with either mechanical or thermal vapour recompression. The evaporators can be provided with built in pre-heaters, pasteurizers, and flash coolers depending on the application. The pre-heated product solution enters into the evaporator forming a thin film all around the internal tubes and by gravity, product internal water can be evaporated.

Because of the water evaporation, the product solution becomes more and more concentrated with solids and obviously more and more viscous. Due to the composition and the viscosity, a limit of evaporation needs to be determined to make possible the transportation of the products especially using pumps and tubes. Usually, the concentrated product is about 48 Tor 65° C. to avoid any growth of thermophilic bacteria.

Homogenisation: Nutritional powders usually contain proteins and fat. To ensure the stability of the product during the reconstitution with water and avoid any oxidation during the storage of the powders before consuming, homogenisation is very important.

Homogenization under high pressure turns fat globules into microscopic size, optimal for digestion, allows the production of dried powder with a low free fat content and make an emulsion with protein avoiding any separation of fat during and after the reconstitution of the finished product with water. By this technology, fat is well distributed and protected into the product and the contact with air is reduced avoiding any further fat oxidation.

Spray Drying: Prior to atomization, the product is pre-concentrated and possibly preheated. The feed should remain liquid and the viscosity kept sufficiently low to allow for proper atomization. However, a higher concentration of dry matter in the feed to the dryer results in reduced energy consumption of the overall process and the powder achieves a higher density. Spray dryers are equipped with a rotary atomizer or high-pressure nozzles. For maximum operational flexibility some dryers can be designed for nozzle as well as rotary atomization. This allows the plant operator to choose the best atomization system for specific products. Air dispensers are designed to fit and to ensure maximum contact between particles and drying air whilst preventing wet particles reaching the chamber wall. The spray drying chamber is sized far the required capacity, and the design is chosen to match the type of atomization used and the product to be dried. Some chambers are equipped with static, integrated fluid beds for better energy utilisation and gentler product treatment at lower temperatures.

The drying chambers have a conical base where the first separation of powder and drying air takes place. The remaining dust from the drying air is removed in a cyclone and/or bag filter. Conventional spray dryers work with cyclones, which are still in use for some applications. However, most modern spray dryers are equipped with a bag filter, which can be cleaned in place. From this bag filter, the powder fraction can be recycled to the process, giving insignificant powder loss.

The powder fraction from the bag filter or the cyclone is recycled to the process, where it can be used for agglomeration. Agglomeration is quite important for this type of nutritional powder as reconstitution, e.g. into water, is a critical property for the consumer. Products need to be easy dissolved, with no deposits or insoluble material, and homogeneous. Agglomeration allows for all these properties, including the powder density control which is important for the packing.

Packing: Usually, powders are stable during the storage but to avoid any damage or deterioration of any properties, the powder products are packed under controlled atmosphere with a residual oxygen content less than 2%, using a blend of nitrogen and carbon dioxide gas. Shelf life of the powder products can be easily 24 months at ambient temperature.

The disclosure of all patents, publications, including published patent applications, and database entries referenced in this specification are expressly incorporated by reference in their entirety to the same extent as if each such individual patent, publication, and database entry were expressly and individually indicated to be incorporated by reference.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. An infant formula composition comprising protein, carbohydrates and lipids effective to supply, per 100 calories, between about 1.8 and 4.5 g of protein, between about 3.3 and 6 g of lipids, and between about 9 and 14 g of carbohydrates, the formulation also comprising between about 1 and 100% of a daily recommended intake of vitamins and minerals, wherein said formulation comprises hemp or a hemp derivative as at least one source of protein, carbohydrate, lipids, vitamins or minerals, or a combination thereof.

2. The composition of claim 1, wherein said hemp or a hemp derivative comprises hulled or dehulled hemp seed, hemp concentrate, hemp protein powder, hemp isolate, hemp oil, hemp liquid or a combination thereof.

3. The composition of claim 1, wherein said composition comprises a protein source in addition to said hemp or a hemp derivative selected from the group consisting of: hemp protein, hemp protein isolate, hemp milk, whey powder, whey protein isolate, whey protein concentrate, milk protein isolate, milk protein concentrate, non-fat milk, non-fat milk isolate, non-fat milk concentrate, casein, skim milk, skim milk powder, skim milk isolate, skim milk concentrate, reduced mineral whey, partially hydrolyzed non-fat milk, fully hydrolyzed non-fat milk, partially hydrolyzed whey protein, fully hydrolyzed whey protein, soy protein, soy protein isolate, casein hydrolysate, free amino acids, amino acids, 100% free amino acids, small peptides, L-amino acids, rice concentrate, pea isolate, pea concentrate, goat's milk protein, goat's milk protein isolate, goat's milk protein concentrate, spirulina, aphanizomen-flos aquae (AFA), clergy sage, chia, flaxseed, yellow pea, quinoa, camu-camu, chlorella, dolse, and kelp.

4. The composition of claim 1, wherein said composition comprises a lipid source in addition to said hemp or a hemp derivative selected from the group consisting of: hemp milk, hemp oil, rice concentrate, pea isolate, pea concentrate, goat's milk fat, cow's milk fat, high oleic vegetable oil, soy oil, medium-chain triglyceride (MCT) oil, long-chain triglyceride (LCT) oil, coconut oil, docosahexaenoic acid (DHA), arachidonic acid (ARA), palm olein oil, high oleic sunflower oil, refined vegetable oil, monodiglycerides, corn oil, safflower oil, palm kernel oil, algal oil, aphanizomen-flos aquae (AFA), spirulina, clergy sage oil, evening primrose oil, flaxseed oil, rice bran oil, soy lecithin, oatbran oil, phenylethylamine (PEA), and lipogen; preferably hemp oil and a source of ALA (alpha linoleic acid).

5. The composition of claim 1, wherein said composition comprises a carbohydrate source in addition to said hemp or a hemp derivative selected from the group consisting of: lactose, corn syrup, maltodexrin, corn syrup solid, high fructose corn syrup, corn, corn maltodextrin, sucrose, modified tapioca starch, modified corn starch, tapioca starch, rice starch, fructose, yucon, dextrin, wood sugar, coconut palm sugar, coconut crystals, coconut sugar, agave, palm nectar and coconut sap sugar; preferably coconut sap sugar, coconut palm sugar, crystallized coconut sap, palm nectar, wood sugar, raw honey, honey, crystallized honey, agave, yacon, or sweet potato, more preferably coconut palm sugar.

6. The composition of claim 1, wherein the protein, lipid and carbohydrates are all partially derived from the hemp or hemp derivative.

7. The composition of claim 1, wherein said vitamins and minerals comprise calcium, phosphorus, sodium, chloride, magnesium, manganese, iron, copper, zinc, selenium, iodine, Vitamins A, E, C, D, K and the B complex, and combinations thereof.

8. The composition of claim 1, wherein the vitamins and minerals are added separately, are whole food derived, or a combination thereof.

9. (canceled)

10. The composition of claim 1, wherein said composition further comprises as at least one source of protein, carbohydrate and lipids, in addition to the hemp or hemp derivative, a dairy, rice, hydrolyzed, goat milk, or soy based composition or formula.

11. The composition of claim 1, wherein said infant formula composition is formulated as a powder, liquid, concentrate, flakes, tablet or capsule.

12. (canceled)

13. The composition of claim 1, wherein an emulsifier is added in an amount effective to stabilize the lipids and increase shelf life of said infant formula composition.

14. The composition of claim 1, further comprising at least one prebiotic and/or at least one probiotic.

15. (canceled)

16. The composition of claim 1, further comprising a source of DHA selected from plant algae (AFA or Blue Green Algae), algal oil, and fish oil sources of DHA.

17. (canceled)

18. The composition of claim 1, wherein said composition is a dry powder ready to blend with water, juice, dairy milk or a plant based beverage; a pasteurized or unpasteurized ready to serve liquid; a pasteurized or unpasteurized frozen liquid to be thawed and warmed before consumption; or a pasteurized or unpasteurized concentrated liquid or frozen concentrate ready to add to water, juice, dairy milk or plant based beverage.

19. The composition of claim 1, comprising
hemp seed at about 1 weight percent of the composition,
rice concentrate, whey powder, whey protein isolate, skim milk powder, milk protein concentrate, pea isolate or a combination thereof at about 61 weight percent of the composition,
lactose at about 19 weight percent of the composition, and
safflower oil, high oleic at about 19 weight percent of the composition.

20. The composition of claim 1, comprising
hemp seed at about 2.5 weight percent of the composition,
rice concentrate, whey powder, whey protein isolate, whey protein concentrate, skim milk powder, milk protein concentrate, pea isolate or a combination thereof at about 59 weight percent of the composition,
lactose at about 19.5 weight percent of the composition, and
safflower oil, high oleic at about 19 weight percent of the composition.

21. The composition of claim 1, comprising
hemp seed at about 4.9 weight percent of the composition,
rice concentrate, whey powder, whey protein isolate, whey protein concentrate, skim milk powder, milk protein concentrate, pea isolate or a combination thereof at about 56.1 weight percent of the composition,
lactose at about 19.5 weight percent of the composition, and
safflower oil, high oleic at about 19.5 weight percent of the composition.

22. The composition of claim 1, comprising
hemp seed at about 36.4 weight percent of the composition,
rice concentrate, whey powder, whey protein isolate, whey protein concentrate, skim milk powder, milk protein concentrate, pea isolate or a combination thereof at about 27.2 weight percent of the composition,
lactose at about 27.3 weight percent of the formulation, and
safflower oil, high oleic at about 9.1 weight percent of the composition.

23. The composition of claim 1, comprising
hemp seed at about 32.6 weight percent of the composition,
rice concentrate, whey powder, whey protein isolate, whey protein concentrate, skim milk powder, milk protein concentrate, pea isolate or a combination thereof at about 14 weight percent of the composition,
lactose at about 41.8 weight percent of the composition, and
safflower oil, high oleic at about 11.6 weight percent of the composition.

24. The composition of claim 1, comprising
hemp powder at about 30 weight percent of the composition
rice concentrate, whey powder, whey protein isolate, whey protein concentrate, skim milk powder, milk protein concentrate, pea isolate or a combination thereof at about 15 weight percent of the composition,
lactose at about 35 weight percent of the composition, and
safflower oil, high oleic at about 20 weight percent of the composition.

25. The composition of claim 1, comprising
hemp powder at about 29 weight percent of the composition
rice concentrate, whey powder, whey protein isolate, whey protein concentrate, skim milk powder, milk protein concentrate, pea isolate or a combination thereof at about 9 weight percent of the composition,
lactose at about 38 weight percent of the composition, and
safflower oil, high oleic at about 24 weight percent of the composition.

26. The composition of claim 1, comprising
hemp isolate at about 30 weight percent of the composition
rice concentrate, whey powder, whey protein isolate, whey protein concentrate, skim milk powder, milk protein concentrate, pea isolate or a combination thereof at about 15 weight percent of the composition,
lactose at about 38 weight percent of the composition, and
safflower oil, high oleic at about 17 weight percent of the composition.

27. The composition of claim 1, comprising
hemp isolate at about 32 weight percent of the composition,
rice concentrate, whey powder, whey protein isolate, whey protein concentrate, skim milk powder, milk protein concentrate, pea isolate or a combination thereof at about 9 weight percent of the composition,
lactose at about 41 weight percent of the composition, and
safflower oil, high oleic at about 18 weight percent of the composition.

28. The composition of claim 1, comprising
hemp liquid at about 5 weight percent of the composition
rice concentrate, whey powder, whey protein isolate, whey protein concentrate, skim milk powder, milk protein concentrate, pea isolate or a combination thereof at about 56 weight percent of the composition,
lactose at about 19.5 weight percent of the composition, and
safflower oil, high oleic at about 19.5 weight percent of the composition.

29-84. (canceled)
